(19) United States
(12) Patent Application Publication
(10) Pub. No.: US 2026/0161488 A1
(43) Pub. Date: Jun. 11, 2026

(54) METHODS AND SYSTEMS FOR PROVIDING A CONTEXT-AWARE CLIPBOARD

(71) Applicant: Adeia Guides Inc., San Jose, CA (US)

(72) Inventors: Charles Dasher, Lawrenceville, GA (US); Dhananjay Lal, Englewood, CO (US); Reda Harb, Saint Petersburg, FL (US)

(21) Appl. No.: 18/971,196

(22) Filed: Dec. 6, 2024

(51) Int. Cl. G06F 9/54; G06F 40/186; G06F 40/30; G06T 7/10

(52) U.S. Cl. CPC G06F 9/543; G06F 40/186; G06F 40/30; G06T 7/10

(57) ABSTRACT

Systems and methods are described for providing a context-aware clipboard. Input data is received, the input data characterizing a detection field of at least one sensor. A first intent is determined, the first intent associated with the input data. One or more second intents are accessed, each of the one or more second intents associated with an application of a plurality of applications. The first intent is compared with the one or more accessed second intents. Based on the comparison, at least one application of the plurality of applications is determined, the determined application associated with the first intent. An operation is performed using the determined application, the operation based on the input data and the determined first intent.

### BACKGROUND

The present disclosure relates to methods and systems for providing a context-aware clipboard. More particularly, but not exclusively, the present disclosure relates to using a context associated with data captured and stored within a context-aware clipboard to determine one or more applications and perform one or more functions using the one or more applications.

### SUMMARY

Various software applications provide manual search and query capabilities to help users locate specific items or information. These applications, often found in e-commerce, asset management, and information retrieval systems, may allow users to input search terms or filters to narrow down large datasets. While these solutions offer a degree of convenience and accessibility, they can often rely heavily on the user's input and knowledge of relevant keywords or categories. Consequently, the efficiency of manual querying is limited by the user's familiarity with the dataset or search terms, often resulting in missed items, for example if a user cannot accurately anticipate or recall the correct terminology. Furthermore, manual querying may be time-consuming and subject to user error, as individuals may overlook items due to imprecise or overly broad search parameters.

The proliferation of specialized applications on user devices may act to provide further complication to the task of locating specific items, information or functionality. With multiple applications catering to distinct functions—such as shopping, productivity, file management, and social networking—users may frequently need to switch between applications to perform searches, for example by remembering or guessing where the relevant information is stored. This fragmentation may result in inefficient receipt and processing of device interactions, associated with a manual search for a correct application and specific search parameters associated with it. A lack of a unified or cross-application search capability may additionally cause unnecessary repetitions of the same or similar queries across multiple platforms. In situations where time is critical, such fragmentation may lead to delays and reduced processing efficiency.

While features like predictive text, auto-completion, and suggested searches assist users in refining their queries, they still rely on a user to know what to search for and how to generate correct or efficient query terms. Many optimizations, such as using machine learning algorithms and natural language processing (NLP) techniques are confined to single applications, lacking cross-platform or multi-application integration. As a result, processing time may be subject to the compounding inefficiencies associated with performing or adapting queries repeatedly across different applications and interfaces, limiting the effectiveness of current search solutions in a fragmented digital environment.

Clipboards are widely used as a quick-access tool for temporarily storing copied information, such as text, images, or files, to facilitate easy transfer between applications. The transient nature of clipboard data, however, can present some limitations. Information stored on a clipboard is typically overwritten with each new copy command, which restricts data handling to one data item at a time and can lead to accidental loss or misplacement of valuable data. For multitasking across multiple applications, such temporary storage can be inefficient and frustrating, as information must be repeatedly copied if used across various tasks. Additionally, many clipboard implementations lack advanced organizational features, making it challenging to keep track of copied items or retrieve older data once it has been replaced.

Systems and methods are described for providing a context-aware clipboard for accepting and storing data to be used for performing tasks across various applications. In some examples, systems and methods are provided for enhancing the capture, processing, and integration of data using a device sensor, such as a device camera. By introducing concepts such as domain intent and active intent, systems and methods are provided taking a context-aware approach configured to tailor data handling processes to the specific needs of an application in use. Presently disclosed systems and methods may introduce features such as persistent and context-aware clipboard management, and cross-device data integration. The systems and methods may, in some examples, support the use of one or more data templates, which may be customizable data templates, and may employ contextual awareness to automatically adjust one or more input data capture settings, for example based on environmental conditions and the type or properties of input data being captured, while considering the active intent and/or domain intent.

According to systems and methods described herein, input data is received, the input data characterizing a detection field of at least one sensor. For example, the input data may be received at or via a server, for example from a user device, or at a processor of the user device. Generally, input data characterizing a detection field of at least one sensor may refer to any input data which is detected by the at least one sensor, or which is associated with the data detected by the at least one sensor. The input data may be any data detected, measured or obtained within, or associated with, at least a portion of the detection field of the at least one sensor. The detection field of the sensor will be understood to mean the field, range, area or domain within which the sensor is configured to receive input data. By way of example, and without limitation, the detection field of the at least one sensor may be a field of view of a camera, an audible detection range of a microphone, a parameter space of a digital data input device (for example a text data input device), or any suitable detection field as will be appreciated. It will be appreciated that the at least one sensor may be any suitable sensor configured for detecting input data, and that the input data may be sensor data, such as raw sensor data, received directly from, or by way of, a sensor of the at least one sensors. In some examples, the input data may be received by way of any suitable intermediary storage device. In some examples, the input data may be received following any suitable processing, formatting, structuring, editing, conversion, translation or interpreting process. The input data may be any suitable combination of input data characterizing each detection field of a plurality of sensors.

In some cases, a user device may be used to capture input image data of an environment. The captured data may be received for storage, for example at a clipboard memory of the user device. The image data may be processed using any suitable image processing tool.

In some examples, a first intent is determined, the first intent associated with the input data. The first intent may be any intent associated with the input data. The determination may comprise any suitable determining and may in some examples comprise a processing of the input data. The determining may be performed at or via a server, for example from a user device, or at a processor of the user device. The term “first intent” will be understood within the context of the present disclosure to mean any purpose, objective, goal, or rationale associated with the input data or the action of inputting thereof. For example, a processing of the input data may be used to derive, predict or estimate any result, meaning, implication, function, pattern, correlation or mapping associated therewith. The first intent may, in some examples, comprise a text, language or semantic component, but examples will be appreciated wherein the first intent may comprise any suitable functional mapping of the input data to one or more outputs.

In some examples, one or more second intents are accessed, each of the one or more second intents associated with an application of a plurality of applications. The one or more second intents may, for example, be stored at, and/or accessed from, any suitable memory, such as for example server memory or local memory of a user device. For example, the one or more second intents may be accessed by or via a server, for example from a user device, or by a processor of the user device. The term “application” will be understood within the context of the present disclosure as any suitable digital application configured for execution on a digital device, such as a user device. In particular, each application will be understood to be configured to execute at least one function on the digital device. The term “second intent” will be understood within the context of the present disclosure to mean any purpose, objective, goal, or rationale associated with operating the corresponding application or at least one function configured to be executed thereby. The second intent may, in some examples, represent a broad operational purpose of the corresponding application. The second intent may, in some examples, comprise a text, language or semantic component, but examples will be appreciated wherein the second intent may comprise any suitable functional mapping of the corresponding application to one or more operational outputs. The one or more second intents may be of the same type or different from the first intent. The one or more second intents may, in some examples, be stored on any suitable memory, for example either locally or remote to a user device, suitable for accessing in accordance with the present methods and systems. The memory may, in some examples, be associated with a clipboard memory. The storing of the second intents may be performed in any suitable manner, for example by way of files, meta-data or tags associated with the corresponding application, the second intents in some embodiments accessible for the purpose of the present systems and methods when the corresponding application is not executed on a device, for example a user device. Examples will be appreciated wherein the storing of the second intents may be performed dynamically at runtime of the corresponding application.

In some examples, the first intent is compared with the one or more accessed second intents. The comparison may be any suitable comparison, and may for example comprise any suitable detecting, measuring, sensing or determining of an association, similarity, correlation, pattern or match between the first intent and at least one of the one or more accessed second intents, or a likelihood thereof. The comparison may, for example, comprise a calculation of a comparison value or score, the comparison value or score proportional to an extent of an association, similarity, correlation, pattern or match between the first intent and at least one of the one or more accessed second intents, or likelihood thereof. The comparison may in some examples comprise the comparing of the comparison value to a comparison value threshold, and wherein the determining of the one or more applications may be based on the comparison value threshold. It will be appreciated that the comparison may comprise any associated processing of the first intent and/or the second intent, which may comprise any suitable adjustment, transformation, conversion, formatting or structuring of the first intent or at least one of the one or more second intents prior to the comparison. Such prior processing may for example be used to minimize errors in the comparison, for example to reduce the rate of false-positives or false negatives. The comparison may comprise one or more stages performed in sequence or in parallel. For example, earlier stages in a sequence of comparison stages may apply a less stringent comparison value threshold, with successive stages in the sequence of comparison stages applying a successively more stringent comparison value threshold. It will be appreciated that the comparison may be performed at or via a server, for example via a user device, or at a processor of the user device.

In some examples, based on the comparison, at least one application of the plurality of applications is determined, the determined application associated with the first intent. The at least one application may, for example, be determined based on an extent of an association, correlation, pattern or match between the first intent and at least one of the one or more accessed second intents, or likelihood thereof. The determining may be performed at or via a server, for example via a user device, or at a processor of the user device.

In some examples, an operation is performed using the determined application, the operation based on the input data and the determined first intent. The operation may be any suitable operation performable using the determined application, and may for example comprise the execution of the application, or a function thereof, on the digital device. For example, the operation may be performed at or via a server, or at a processor of the user device. In examples wherein the operation is performed at or via a server, an output or result of the operation may be communicated to a user device.

In some examples, receiving the input data may comprise receiving first said input data and receiving second said input data. The second input data may comprise the same or different data to the first input data. In some examples, the second input data may be received at different times. For example, in some implementations the second input data may be received following the determination of the application, for example immediately following the determining of the application and prior to the performing the operation. In some such examples, receiving the second input data is based on the determined application. In some examples, the performing of the operation is based on the second input data. In some examples, the second input data may be received following the performing of the operation. For example, the second input data may be associated with input commands received after the performing of the operation.

In some examples, determining of the first intent may comprise performing a semantic analysis on at least a portion of the input data. Any suitable semantic analysis may be performed on the at least a portion of the input data. The term “semantic analysis” will be understood within the context of the present disclosure to mean any suitable manner of establishing a semantic association from the input data. The semantic analysis may, for example, comprise accepting as input at least a portion of the input data, which may in some examples be raw unstructured data. The semantic analysis may then output a structured, interpretable representation of the at least a portion of the input data as the first intent. The form of semantic analysis performed may, for example, correspond to a data type of the at least a portion of the input data. It will appreciated that the semantic analysis may comprise any suitable processing of the at least a portion of the input data, and may include any suitable pattern-recognition, classification, clustering, and mapping.

In some examples, the input data may comprise text or language data. In such examples, the input data may comprise any one of, or any combination of, text data and audio data comprising speech. In some examples, the determining of the first intent may comprise performing a semantic analysis on at least a portion of the input data. For text data, the semantic analysis may, for example comprise one or more processes selected from: natural language processing (NLP); syntactic parsing; named entity recognition (NER); sentiment analysis; topic modelling; tokenization; stemming; lemmatization; language detection; entity linking; or part-of-speech (POS) tagging. For audio data, the semantic analysis may, for example, comprise one or more processes selected from: speech to text (STT) conversion; natural language processing (NLP); speech recognition; or emotion recognition.

In some examples, the input data may comprise image data characterizing a field of view of an imaging device, and wherein the semantic analysis comprises semantic segmentation of the image data. Examples will be appreciated wherein any suitable semantic analysis may be performed on the image data and may, for example, comprise one or more processes selected from: object detection; object classification; segmentation; feature matching; or scene understanding. It will be appreciated that any suitable image processing may be performed on the image data, for example resizing, normalizing (for example scaling pixel values), transformation (such as rotation or flipping).

In some examples, following the determining of the application: an interactive element may be output, the interactive element associated with the determined application. The term “interactive element” will be understood within the context of the present disclosure to mean any element suitable for receiving an interaction, for example an input command, such as from a user. The interactive element may be output in any suitable manner. For example, the interactive element may be received at or via a server, for example from a user device, or at a processor of the user device, for output. In some examples, the interactive element may be stored in any suitable storage, such as at a user device, and may be accessed by way of the storage for the output. In some examples, the output may comprise an overlay of one or more elements or information over the interactive element, such as the stored interactive element. In some examples, the one or more elements or information may be received during or following the determination of the application, for output alongside, or overlaid over, the interactive element. The output of the interactive element may in some examples be by way of display of the interactive element on a display screen.

In some such examples, an indication of an interaction with the interactive element may be received. The indication of the interaction with the interactive element may be received following a detection of the interaction by way of any suitable interaction detection method, for example the detection of a touch-based input-command, detection of a gesture-based input command, detection of a speech-based input command, detection of a gaze-based input command, or any suitable input command detection as will be appreciated. A user device may be configured, in some examples, to detect the interaction with the interactive element using any suitable such input command detection. In some examples, each input command type of a plurality of input command types may be associated with a corresponding operation or execution of the determined application. For example, each gesture-based input of a plurality of gesture-based inputs may be associated with a corresponding operation or execution of the determined application. In some examples, the interactive element may comprise any suitable link, for example a deeplink, associated with a corresponding one of the plurality of applications or a function thereof.

In some examples, the performing of the operation using the determined application may be performed prior to the output of the interactive element. In such examples, the interactive element may comprise, at least a portion of an output or result of the operation. In some examples, the interactive element comprises a portion of the output or result, the portion being less than the complete output or result. As such, in some examples, a preview of the operation output or result may be provided as part of the interactive element for the determined application.

In some examples wherein second input data is received following the determination of the application or the receiving of the indication of the interaction with the interactive element, the receiving of the second input data may comprise displaying an unobstructed output or display, for example of a camera feed, at a user device. The provision of an unobstructed output or display for receiving the second input data may provide minimal obstructions to viewing, for example a camera feed of an environment, for the purpose of receiving or capturing the second input data.

In some examples, the operation may comprise: generating, using the input data, a query based on the first intent. In some examples, the generated query may be output, for example for viewing by a user. Instructions may be received to modify the query, for examples a user view the output query may modify the query such that the query more closely reflects the user's intent. The received instructions may be used, in some such examples, the modify the first intent. As such, a feedback loop may be provided for optimizing the first intent to more closely reflect an intent of a user.

In some examples, the operation may further comprise performing the query using the determined application. In some examples therefore, the systems and methods may comprise a context-aware autonomous query generation based on the input data, and optionally an autonomous execution of the generated query. The term “generating a query” will be understood within the context of the present disclosure to mean any suitable processing of the input data based on the first intent, to provide a structured output configured to be received and processed as a query compatible with a corresponding database, search engine, or API associated with the determined application. In examples wherein the operation comprises executing the application, for example on a user device, the generating of the query may in some examples be performed before the executing of the application. In such examples, the pre-filling or pre-generating of queries may improve operational efficiency in associated systems and methods.

In some examples, determining the application may comprise determining an input data type of the one or more applications, the input data type defining one or more data types with which the one or more applications are configured to process, receive, use or engage. Such a compatibility assessment of the input data with the one or more applications may reduce compatibility issues in associated systems and methods. In some examples, application input data may be generated using the input data, the application input data generated based on the determined application, for example based on the determined input data type associated therewith. In some examples the input data may be modified based on the determined application, for example based on the determined input data type associated therewith. A modification of the input data, or the generation of application input data based thereon, may in some examples provide improved compatibility of the input data with the determined application.

In some examples, the input data may be formatted or structured based on the determined application. For example, the input data may be formatted or structured to be received by the determined application, such as for the purpose of performing the operation (for example a query). In some examples, the formatting or structuring of the input data may be based on a predetermined data template associated with the determined application. The predetermined template may be any suitable template, and may in some examples comprise one or more formatting or structuring instructions for formatting or structuring the input data. In some examples, the template may comprise one or more predefined parameters of a function or operation, such as a call made to an application programming interface (API) (such as a GET request).

In some examples, at least a portion of the input data may be identified as compatible with the determined application, and wherein the operation is performed based on said compatible input data portion. Such an identification may be performed in any suitable manner, and in some examples the input data may be modified to remove at least a portion of the input data type which is identified as not compatible with the determined application.

In some examples, wherein receiving the second input data is based on the determined application, the determined application may comprise one or more input data parameters, which may comprise one or more input data structures or input data formats. One or more second input data sensing parameters may be communicated, based on the one or more input data parameters of the determined application, for example for use in sensing the second input data by the at least one sensor. In such examples, the one or more second input data sensing parameters may define a sensing mode or capture mode of the at least one sensor for sensing the second input data, which may comprise defining the detection field of the at least one sensor. By way of example, an application of the one or more applications may be configured to receive input data of a specified type, format or structure. The application may therefore be used to define a sensing mode or capture mode for sensing or capturing the second input data, such that the second input data is sensed or captured having the specified type, format or structure to be received by the determined application. Examples will be appreciated wherein the second input data may be formatted or structured after the sensing, capturing or receiving thereof, for example based on a predetermined template associated with the determined application.

In some examples, instructions to process or modify the input data may be received. The input data may be processed or modified in any suitable manner, and may in some examples be processed or modified based on an input data type of the input data. For example, text data processing or modification may comprise optical character recognition (OCR) or reformatting (for example using portable document format (PDF) conversion), and image data processing or modification may comprise any suitable image processing or spatial data extraction, estimation or capture.

In some examples, the determined first intent may be stored. It will be appreciated that the first intent may be stored in any suitable memory, for example local memory of a user device, or remote memory at, for example, a server. The memory may, in some examples, be a memory associated with a clipboard. In some examples, instructions to execute a second application of the plurality of applications may be received. It will be understood that the second application may be different to the determined application. The instructions to execute the second application may be received in any suitable manner, for example following an indication of an interaction with an interactive element associated with the second application. In some examples, the stored first intent may be accessed in response to the received instructions to execute the second application; and a second operation may be performed using the second application, the operation based on the input data and the stored first intent. As such, the first intent may be stored and used for performing operations across different applications among the plurality of applications, for example following receipt of the instructions to execute a different of the plurality of applications.

In some examples, the first intent may be modified based on the second input data. In some examples, a second determination of the first intent may be performed based on the first input data and the second input data. In such examples, further input data, such as the second input data, may provide an improved accuracy, precision, confidence or certainty value associated with the determination of the first intent. In some examples, the first intent may be updated based on the second input data, for example based on the updated determination. In some examples, the modification of the first intent may be detected, and in response to said detection, a further said accessing of the one or more second intents and/or a further said comparison may be performed. Based on the further accessing or the further comparison, a second determination of the at the least one applications may be performed. In some examples, it may be determined that an application of the second determination is already executed on a user device. In such examples, the second intent of the device may be updated based on the modified first intent.

In some examples, accessing the one or more second intents may comprise: communicating a request for one or more second intents to at least one of the plurality of applications. In some examples, the request may be communicated to each of the plurality of applications. In some examples, the request may be communicated to a second intent memory location or address, database or look-up table, storing each of the second intents. In some examples, each of the plurality of applications may be stored on, or configured to be executed on, a user device. In some examples, accessing the one or more second intents may comprise accessing at least one second intent associated with each one of the plurality of applications of the user device. In some examples, accessing the one or more second intents may comprise accessing a memory, for example storing any suitable database, register or look-up table comprising the one or more second intents. In some examples, accessing the one or more second intents may comprise identifying, of the one or more second intents, at least one second intent associated with the first intent. Such a pre-screening of the second intents may occur prior to the comparison and may reduce the processing resource requirement for the comparison.

In some examples, the input data (for the example the first input data, the second input data, or both) may comprise one or more types of data selected from: sensor data; image data; audio data; text data; location data; orientation data; dimension data; depth data; point cloud data; time of flight data; weather data; temperate data; or pressure data. Any suitable input data will be appreciated, wherein the input data may comprise one or any combination of suitable input data types.

In some examples, the input data may be stored in any suitable memory, for example a local memory of a user device, or at a memory of a remote server. The memory may, in some examples, be a memory associated with a clipboard. The input data may be stored alongside or in association with the first intent. For example, storing the input data may comprise modifying the input data, for example meta data associated therewith, to include an association with the first intent. The storing of the input data may in some examples comprise storing the first input data, storing the second input data, or storage any combination of the first input data and the second input data. In some examples, the memory may be configured such that the second input data may be stored without modifying, removing, deleting or overwriting the stored first input data. In some examples, the input data may be compressed by any suitable compression method prior to storage. The memory, which may be a clipboard memory, may be configured to store input data of more than one input data type simultaneously.

In some examples, the storing of the input data may comprise modifying the input data, for example meta data associated therewith, to include an association with the determined application. In some examples, the stored input data may be accessed by, or for use within, the determined application based on the modification.

In some examples, the stored input data and/or the stored first intent may be accessible by one or more of the plurality of applications. In some examples, the stored input data and/or the stored first intent may be accessible by each of the plurality of applications. Such accessibility may, in some embodiments be based on an authorization status, wherein a positive authorization status may provide accessibility of the stored input data and/or the stored first intent to the corresponding application, and a negative authorization status may restrict or revoke accessibility of the stored input data and/or the stored first intent to the corresponding application. In some examples, instructions may be received to modify the authorization status for one or more of the plurality of applications between the negative authorization and the positive authorization. Applications may therefore be provided with permission to access the stored input data and/or the stored first intent, for example by a user. The authorization status may, in some embodiments be based on the comparison, and may for example be based on a threshold similarity of a second intent of an application to the first intent. As such, the permissions for a particular application to access the stored input data and/or the stored intent may in some examples be based on the relevance of a second intent of the application to the determined first intent. In such embodiments, only applications having second intents within a threshold relevance to the first intent may be provided with the required authorization to access the stored input data and/or the stored first intent. Such authorizations or permissions may be implemented in any suitable manner, and may in some examples regulate the sharing of input data and/or the first intent between applications.

The operation may comprise determining one or more characteristics of the input data based on the first intent or the second intent of the determined application. The one or more characteristics may, for example, be associated with a function of the determined application. The determining of the one or more characteristics of the input data may comprise attributing a relevance value to at least a portion of the input data, the relevance value for example indicating a relevance of the portion of the input data to the first intent or the second intent. For example, in some cases wherein the input data comprises image data, the one or more characteristics may comprise one or more visual characteristics of the image data. The one or more visual characteristics may be any suitable visual characteristic, and may be one or more characteristics selected from: color; shape; texture; size; dimension; quantity; frequency; position; orientation; location; brightness; contrast; resolution; blur; visibility; occlusion; or classification. The one or more visual characteristics may, for example, be used to perform any suitable visual data processing, such as tagging, classification, segmentation or object recognition using the input data. The visual data processing, such as object or feature tagging, may be based on a relevance of an object or feature of the image data to the first or second intent, and may comprise the attributing of a corresponding relevance value to one or more of said objects or features.

It will be appreciated that any process steps and functionality of the present disclosure, in any suitable combination thereof, may be performed on a user device or at a server. The performance of steps or functionality at a server may in some cases act to conserve memory and computational processing resources on a user device.

It will be appreciated that any features described herein as being suitable for incorporation into one or more examples of the present disclosure are intended to be generalizable across any and all examples of the present disclosure.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of an example system for providing a context-aware clipboard, in accordance with some examples of the disclosure;

FIG. 2 is a block diagram showing an alternate visualization of portions of the example system of FIG. 1 for providing a context-aware clipboard, in accordance with some examples of the disclosure;

FIG. 3 is a flowchart representing steps of an example process for providing a context-aware clipboard, for example using a system of the examples of FIG. 1 and FIG. 2, in accordance with some examples of the disclosure;

FIG. 4 is a sequence diagram indicating more detailed steps of the example process of FIG. 3;

FIG. 5 shows an example display screen of a user device implementing a step in the example process of FIG. 4 in accordance with the present disclosure, the display screen displaying a plurality of interactive elements each corresponding to an application suitable for use in the process;

FIG. 6 shows a further example display screen of a user device implementing a step of the example process of FIG. 4 in accordance with the present disclosure, the display screen displaying a room dimensions process performed on an application of the user device;

FIG. 7 shows a further example display screen of a user device implementing a step of the example process of FIG. 4 in accordance with the present disclosure, the display screen displaying a room layout and product placement process performed on an application of the user device;

FIG. 8 shows a further example display screen of a user device implementing a step of the example process of FIG. 4 in accordance with the present disclosure, the display screen displaying a query process performed on an application of the user device;

FIG. 9 to FIG. 15 each show a sequence diagram indicating steps of a corresponding alternate example process to that described in relation to FIG. 4, for example using a system of the examples of FIG. 1 and FIG. 2, in accordance with systems and methods of the present disclosure;

FIG. 16 is a flowchart representing steps of a further example process for providing a context-aware clipboard, as an alternative to the example described in relation to FIG. 3 for example using a system of the examples of FIG. 1 and FIG. 2, in accordance with some examples of the disclosure;

FIG. 17 is a flowchart representing steps of a further example process for providing a context-aware clipboard, as an alternative to the example described in relation to FIG. 3 for example using a system of the examples of FIG. 1 and FIG. 2, in accordance with some examples of the disclosure; and

FIG. 18 is a block diagram showing components of an example system for providing a context-aware clipboard, in accordance with some examples of the disclosure.

### DETAILED DESCRIPTION

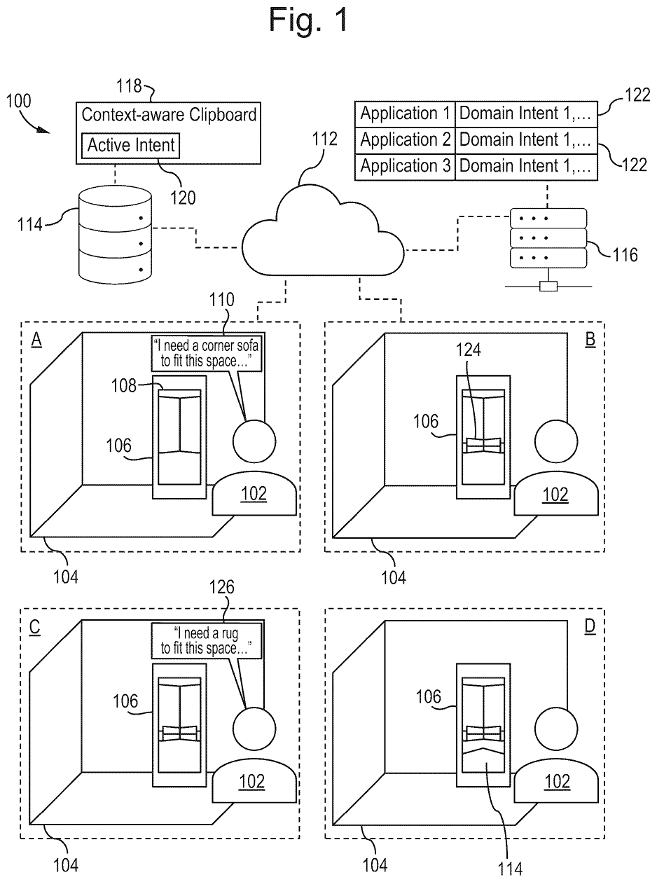

FIG. 1 illustrates an overview of an example system 100 for providing a context-aware clipboard, for example users of an extended reality device. A first user 102 may arrive at a space, for example a room 102 of their new home. The room 104 of the user's new home may be without furniture, and while in the room 104 the user 102 may therefore decide to explore options for furnishing the room 104. The user 102 may use their mobile device 106 to search for options for furnishing the room 104. The systems and methods provided herein provide the user 102 with a persistent, context-aware clipboard configured for providing a seamless search experience configured to be used across multiple applications with reduced interaction and input, and corresponding device compute required.

The example shown in FIG. 1 shows a sequence of user interactions A, B, C, D with a mobile device of the user 102 during the user's search for furnishing options for their new home, the user 102 positioned within the room 104 of their new home for each interaction A, B, C, D. In particular, the user 102 has identified a corner of the room 104 requiring furnishing.

The system 100 shown comprises a user device 106 carried by the user 102. In the example shown the user device 106 is a smartphone 106 of the user, but examples will be appreciated wherein the user device 106 is any suitable device, such as any extended reality device comprising a head-mounted display (HMD), for example any augmented reality-enabled device, any virtual reality-enabled device, any mixed reality-enabled device, any spatial computing-enabled device, a smartphone, a tablet computer, or the like, the device configured to display or otherwise provide visual content to one or more respective users. The user device 106 comprises a plurality of sensors (not shown) including a camera having an image sensor and a depth sensor, a microphone, and a plurality of orientation sensors including an accelerometer, a gyroscope and a magnetometer. The sensors of the mobile device 106 each comprise one or more detection fields setting the bounds for input data being detected thereby. For example, the image sensor of the camera comprises a sensor size and focal length defining the field of view of the image sensor. In some examples, the detection field of one or more of the sensors maybe adjustable according to one or more adjustable detection field parameters. The adjustability of the detection field, such as the parameters thereof, may for example be by way of receipt of input instructions, such as following interaction from a user. Each of the sensors is configured to detect corresponding input sensor data characterizing the detection fields thereof, and provide the input sensor data for storage.

With the ever-improving capabilities of the Internet, mobile computing, and high-speed wireless networks, users are accessing media on user equipment devices on which they traditionally did not. As referred to herein, the phrases “user device”, “user equipment device”, “user equipment”, “computing device”, “electronic device”, “electronic equipment”, “media equipment device”, or “media device” should be understood to mean any device for displaying and or capturing input sensor data, such as image data, as described above. In some examples, the user device may have a front-facing screen and a rear-facing screen, multiple front screens, or multiple angled screens. In some examples, the user device 106 may have a front-facing camera and/or a rear-facing camera.

The system 100 may also include network functionality 112 such as the Internet, configured to communicatively couple user devices 106 to one or more servers 114 and/or one or more application databases or servers 116 from which applications and application data may be uploaded for storage by, and/or accessed for display on, the user device 106. The user device 106 and the one or more servers 104 may be communicatively coupled to one another by way of the network 112, and the one or more servers 114 may be communicatively coupled to the application database or server 116 by way of one or more communication paths, such as a proprietary communication path and/or the network 112. In some examples, the one or more servers 114 may be a server of a context-aware clipboard provider which provides context-aware clipboard functionality, including associated processing and storage, for accessing on user devices 106.

In the example 100 shown, in a first interaction A with the user device 106, the user 102 identifies a corner space within the room 104 which requires furnishing. The user device 106 receives an input command from the user 102 to execute a camera application thereon, which is configured to initiate capturing of input sensor data by sensors of the camera of the user device 106, which in the example 100 shown is a rear-facing camera. The user 102 directs the rear-facing camera (not shown) of the user device 106 toward the corner space of the room 104, such that the image sensor of the camera is configured to detect and capture input image data characterizing the field of view of the image sensor directed toward the corner of the room. The depth sensor of the camera is also configured to detect and capture depth data characterizing the detection field thereof, the depth data in the example shown comprising time-of-flight (TOF) data. Examples will be appreciated wherein any suitable input data may be detected and captured, such as for storage, and wherein any suitable input data may be captured and processed prior to storage as input data. For example the input image data and the input depth data may be processed by a processor of the mobile device 106 prior to storage as, for example three-dimensional (3D) data, such as point cloud data.

A front-facing display 108 of the user device 106 is configured to output a real-time display of the input image data from the image sensor as shown. In the first interaction A shown, the user 102 directing the camera of the user device 106 toward the corner of the room 104 requiring furnishing, utters a spoken command 110 comprising, “I need a corner sofa to fit this space . . . ”. The microphone of the mobile device 106 is configured to detect and capture the spoken command 110 as input audio data for storage. The mobile device 106 is configured to communicate the input image data and the input depth data characterizing the corner of the room 104, and the input audio data characterizing the spoken command 110, to the server 114 for storage on the context-aware clipboard 118 by way of the network 112. Examples will be appreciated wherein the context-aware clipboard 118 functionality is provided directly on the user device 106, for example as a feature of a local operating system thereof.

In the example 100 shown, a processor of the server 114 is configured to process the input image data, the input depth data and the input audio data and determine an active context or an active intent 120 associated therewith. The determination of the active intent 120 in the example 100 shown comprises a semantic analysis of the input data, such as a natural language processing (NLP); speech recognition; and emotion recognition processing of the input audio data. For example, from the input audio data characterizing the spoken command 110, it may derived that the active intent includes “room layout” and “sofa”. Examples will be appreciated wherein any suitable processing of the input data may be performed to establish the active intent, as described herein.

The processor of the server 114 is further configured to access a list of available applications stored for execution on the user device 106, and based on the list access by way of the application database or server 116 a list of stored domain intents 122 associated with each of the applications stored for execution on the user device 106. For example, the user device 106 may have stored for execution thereon a first application associated with sofa manufacture and supply, and a second application associated with rug manufacture and supply. The first and second applications may each be configured to provide a product design and placement feature in which, having an awareness of dimension features of a room, a product placement operation or function of the respective application may be executed to identify a virtual representation of a product and position the virtual representation of the product for display at a virtual location and orientation in the room. The first application may therefore comprise the associated domain intent, “room layout for placing sofas”, and the second application may therefore comprise the associated domain intent, “room layout for placing rugs”.

Having access to the active intent 120 and the list of stored domain intents 122, the processor of the server 114 is configured to perform a comparison of the active intent 120 and the domain intents 122. In the example shown, the comparison comprises a similarity assessment in which a similarity score is applied to each of the domain intents 122 corresponding to a determined similarity to the active intent 120. The similarity assessment is performed using a semantic analysis of the active intent 120 and the domain intents 122. Examples will be appreciated wherein the comparison is performed using any suitable method such as described herein. In the example 100 shown, the domain intent of the first application, “room layout for placing sofas” may be identified as having the highest similarity score relevant to the active intent 120 including “room layout” and “sofa”. In response to the comparison, and based on the results thereof, the first application may be selected from the list of application.

Following the selection of the first application, the processor of the server 114 may be configured to cause the execution of the first application on the user device 106. The first application may be configured to access the input data from the active clipboard 118 of the server 114, for example based on the similarity score, and following accessing of the input data by the first application, the first application is configured to execute the product placement operation thereof using the input data, and in alignment with the active intent identified for the user. The output of the product placement operation in the example 100 is shown in interaction B in which, having awareness of room dimension data from the input image data and the input depth data stored at the clipboard 118, the first application identifies a sofa from a plurality of sofas, the identified sofa having dimensions corresponding to those indicated in the input image data and the input depth data. Following the identification of the sofa, the first application is configured to, using the product placement operation, determine a position and orientation for the sofa, and output a virtual representation of the sofa 124 for display at the determined position and orientation on the display screen 108. Examples will be appreciated wherein the product placement operation may be performed in any suitable manner.

At interaction C of the example 100 shown, the user 106 may, having a visualization of the sofa 124 virtually positioned in the room 102 on the display screen 108, utter the spoken command 126, “I now need a rug to fit this space . . . ” for detection and capture by the microphone of the user device 106. In the interaction C shown, the display screen data, comprising the sofa 124 positioned in the room 102, is also configured to be captured by the user device 106 as input image data, following the detection of the spoken command 126.

The mobile device 106 is configured to communicate the further input image data characterizing the content of the display screen 108, and the further input audio data characterizing the spoken command 126, to the server 114 for storage on the context-aware clipboard 118 by way of the network 112. The context-aware clipboard 118 in the example shown comprises persistent storage functionality for multiple input data types, and the input data stored thereon associated with the previous interaction is updated using the further input image data and the further input audio data, but is not overwritten.

In the example 100 shown, a processor of the server 114 is configured to process the collection of the input image data, the input depth data, the input audio data, the further input image data and the further input audio data, and determine an updated active context or an active intent 120 associated therewith. The determination of the updated active intent 120 in the example 100 shown comprises a semantic analysis of the input data, such as a natural language processing (NLP); speech recognition; and emotion recognition processing of the input audio data. For example, from the input audio data characterizing the spoken command 126, it may derived that the updated active intent includes “room layout” and “rug”. Examples will be appreciated wherein any suitable processing of the further input data may be performed to establish the updated active intent, as described herein.

The processor of the server 114 is further configured to access the list of available applications stored for execution on the user device 106, and based on the list access by way of the application database or server 116 a list of stored domain intents 122 associated with each of the applications stored for execution on the user device 106. Having access to the updated active intent 120 and the list of stored domain intents 122, the processor of the server 114 is configured to perform a comparison of the active intent 120 and the domain intents 122 as described. In the example 100 shown, the domain intent of the second application, “room layout for placing rugs” may be identified as having the highest similarity score relevant to the updated active intent 120 including “room layout” and “rug”. In response to the comparison, and based on the results thereof, the second application may be selected from the list of application.

Following the selection of the second application, the processor of the server 114 may be configured to cause the execution of the second application on the user device 106. The second application may be configured to access the input data and further input data from the active clipboard 118 of the server 114, for example based on the similarity score, and following accessing of the input data and further input data by the second application, the second application is configured to execute the product placement operation thereof using the input data and the further input data, and in alignment with the updated active intent identified for the user. The output of the product placement operation in the example 100 is shown in interaction D in which, having awareness of room dimension data from the input image data, the further input image data, and the input depth data stored at the clipboard 118, the first application identifies a rug from a plurality of rugs, the identified rug having dimensions corresponding to those indicated in the input image data, the further input image data, and the input depth data. Following the identification of the rug, the second application is configured to, using the product placement operation, determine a position and orientation for the rug, and output a virtual representation of the rug 128 for display at the determined position and orientation on the display screen 108. Examples will be appreciated wherein the product placement operation may be performed in any suitable manner.

As such, the systems and methods described herein may provide, based on a small number of input commands, for example a single input command, a complete end-to-end processing of a search or query operation using a context-aware clipboard. In the example 100 described, the active intent 120 represents a dynamic intent of the user and is subject to change, whereas the domain intents 122 stored in association with each application represent the broad operational functions and capabilities of the corresponding application, and are predetermined and static. Examples will be appreciated wherein the domain intents may also be dynamic and updated, for example following an update or patch to an application which adds further functionality thereto. In the example shown, only a single domain intent was described in relation to each application, but as is apparent from FIG. 1, each application may comprise multiple operations and functions, and may therefore comprise any number of domain intents associated therewith. By having a rich taxonomy of “domain intents” associated with each application, a user's active intent in taking an image/video can be efficiently translated into processing by the appropriate application, or even by multiple applications. Some examples may implement security features including an application permission or authorization status indicating authorization of an application to access the input data, for example that stored on the clipboard. The authorization in the example 100 shown was determined based on the similarity score, and therefore the relevance of the input data to the application driven by the active intent. Examples will be appreciated wherein any suitable authorization or permissions process may be implemented.

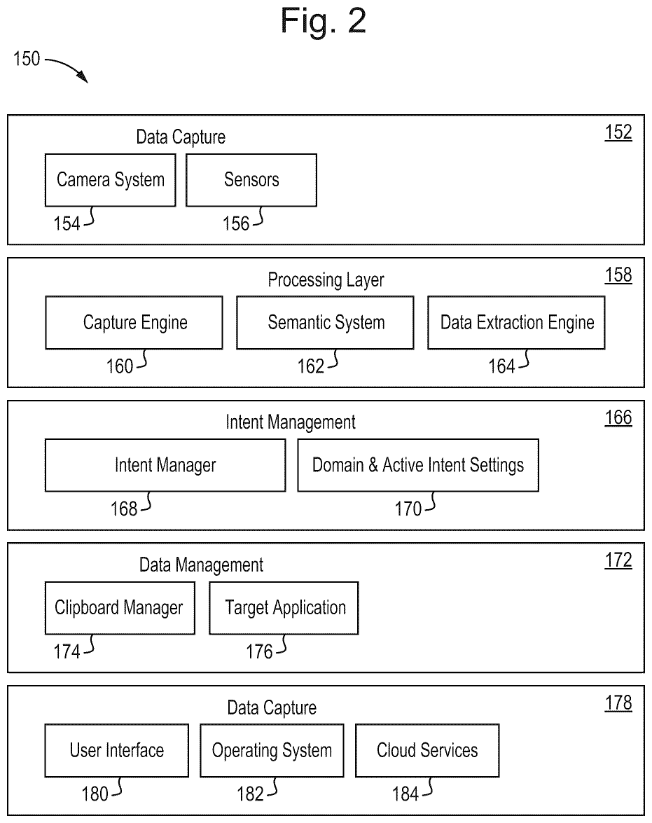

FIG. 2 shows an alternate view 150 of components of the system 100 of FIG. 1, for implementing a context-aware clipboard in accordance with systems and methods of the present disclosure. As seen in the alternate view 150 of FIG. 2, the system 100 in the view of FIG. 2 comprising a plurality of system layers including a data capture layer 152 implementing a camera system 154 and a plurality of additional sensors 156 as described in relation to FIG. 1, including a depth sensor, a microphone and a digital data sensor configured to capture display screen data.

The system 100 further comprises a processing layer 158 configured to perform processing tasks associated with, for example, processing the input data for determining the active intent. The processing layer 158 may comprise any suitable processing functionality associated therewith and in the example shown comprises a capture engine 160 configured to initiate capture and storage of input data, a semantic system 162 configured perform semantic analysis of the input data such as that described. While the semantic analysis described in relation to the example 100 of FIG. 1 comprised a semantic analysis of input audio data, the semantic system 162 may be configured to perform semantic analysis on any suitable input data types, for example text data, image data, and may comprise cooperation with a data extraction engine 164 of the system 150 for performing semantic analysis on, for example feature extraction data performed by the data extraction engine 164.

The system 100 shown in the view 150 of FIG. 2 further comprises an intent management layer 166 configured for monitoring and identifying active and domain intents. The intent management layer 166 comprises an associated intent manager 168 configured to interact with the active intent determination process, for example by way of predetermined domain and active intent settings 170.

The system 100 shown in the view 150 of FIG. 2 further comprises a data management layer 172 configured to manage interactions with the input data of the clipboard by the determined application by way of a clipboard manager 174 and a target application communication module 176. The data management layer 172 may, for example, manage access to input data of the clipboard, for example in accordance with application permissions as described.

The system 100 shown in the view 150 of FIG. 2 further comprises a system control layer 178 configured for managing communication and processing control signals, for example between a device-side user interface 180, a device-side operating system 182 and one or more cloud services 184 utilized for implementing the context-aware clipboard as described.

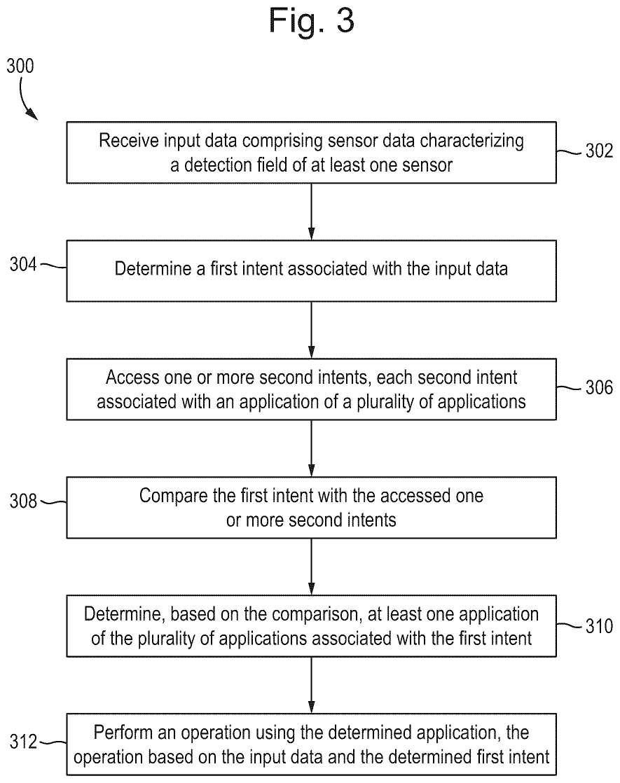

FIG. 3 shows a flowchart representing an illustrative process 300 for implementing a context-aware clipboard such as that described using the system 100 of FIG. 1 and FIG. 2. At 302, the process comprises receiving input data comprising sensor data characterizing a detection field of at least one sensor. As described in relation to FIG. 1, the input data may be any suitable data and may include text or language data input by way of a text-input interface or by way of audio data, for example by way of a microphone. At 304, the process 300 comprises determining a first intent associated with the input data. The determination of the first intent, for example the active intent determined in the example 100 of FIG. 1, may for example include a semantic analysis of the input data, such as any text or language data comprised therein. Examples will be appreciated wherein a semantic context may be determined for any input data types, such as input image data, using any suitable semantic analysis method. Examples will be appreciated wherein the determination of the first intent may comprise non-semantic associated processing components, for example any suitable un-supervised processing or saliency analysis of image data.

At 306, the process 300 comprises accessing one or more second intents, each second intent associated with an application of a plurality of applications. The second intents may, for example, be associated with a broad operation, function or purpose of the associated application, as described in relation to the domain intents of the example 100 of FIG. 1. The second intents may be stored or registered by an application at any suitable memory, and may for example be stored at an application sever associated with the application, or may be stored in data local to a user device, for example in metadata associated with the local storage of the application. An application having more than one function or functional purpose may comprise more than one second intent, each second intent associated with a corresponding one or more of the functions or functional purposes of the application. In the example described in relation to FIG. 1, the broad functional purpose of the first application is product placement of sofas, and the corresponding second intent comprised “room layout for placing sofas”. Many applications exist having varying functions or representing diverse catalogues of products and product types, and such applications may comprise a number of second intents proportional to the available products or product types associated with the application.

At 308, the process 300 comprises comparing the first intent with the accessed one or more second intents. Any suitable comparison may be performed, for example a similarity or proximity assessment as described in relation to the example 100 of FIG. 1. As described in relation to FIG. 1, the output or result of the comparison, which may for example include a similarity score, may be used in some examples to determine a level access permissions or authorization for access to one or more portions of the input data by the application. For example, one or more portions of the input data may be determined to comprise sensitive information, for example identification information of one or more users, and such portions of the input data may be allocated a higher permissions or authorization threshold than other less sensitive portions of the input data.

At 310, the process further comprises determining, based on the comparison, at least one application of the plurality of applications associated with the first intent. The determined application may be used, at 312 of the process 300, to perform an operation, the operation based on the input data and the determined first intent. Thereby, the operation is driven by the determined first intent of the input data such that the context associated therewith is maintained in the performance of the operation. This feature therefore may provide an end-to-end processing of input data while requiring minimal input commands from a user.

It will be understood that various modifications may be made to process 300 in accordance with the present disclosure. For example, the steps of the process 300 may be performed in any suitable order.

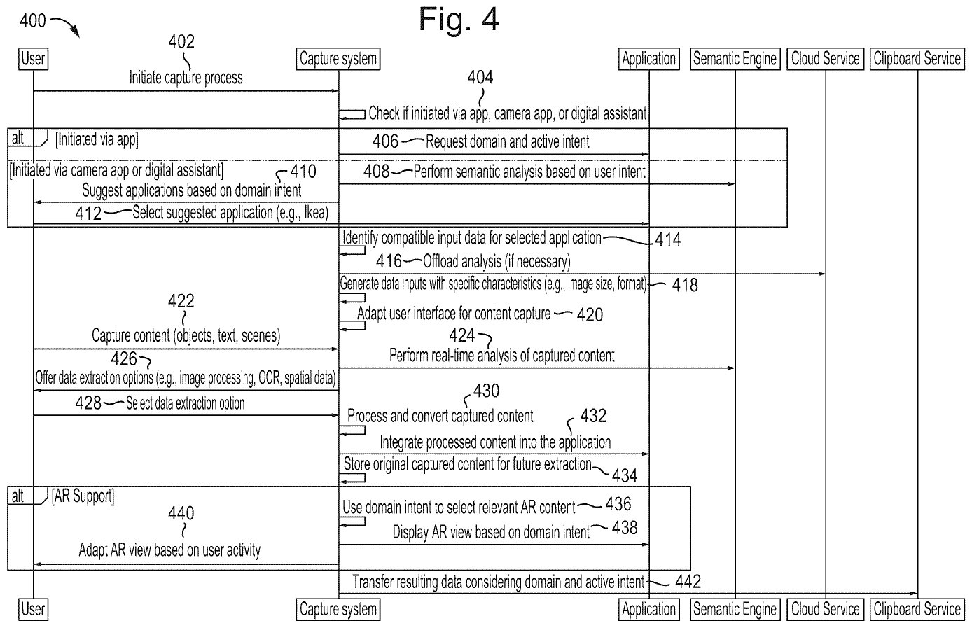

FIG. 4 shows a sequence diagram detailing steps of an example process 400 used for implementing a context-aware clipboard in accordance with the present disclosure, suitable for use with the system of FIG. 1 to FIG. 2, and in accordance with the method 300 of FIG. 3.

In particular, the steps of the process 400 may make use one or more of elements of a system 200 as described in relation to FIG. 2. In particular, the process 400 makes use of a capture system, an application, for example a clipboard application, a camera application or a digital assistant, a semantic engine, a cloud service, and a clipboard service. It will be appreciated that the system elements used in the implementation of FIG. 4 may be any suitable elements which are located either locally to a user device or remote by way of one or more servers, or any combination thereof.

At 402, interaction or input commands may be received by way of the capture system, such as from a user, to initiate the input data capture process. At 404, the capture system may check if the capture process was initiated by, or via, a clipboard application, a camera application, or a digital assistant. In process steps initiated by an application at 406, the capture system may request one or more domain intents and one or more active intents from, or by way of, the clipboard application.

In process steps initiated by, or via, a camera application or a digital assistant, at 408 the capture system may perform semantic analysis, using the semantic engine, on input data indicative of a user intent. At 410, the capture system may, for example suggest applications based on one or more domain intents thereof. At 412, an indication may then be received, for example associated with a user selection, of one of the one or more applications. At 414, the capture system may identify compatible input data for the selected application, for example by using a cloud service to offload any associated processing or analysis at 416. At 418, the capture system may then generate one or more input data, which may comprise specific input data characteristics (e.g., image size, data format, among others as described herein). At 420, the capture system may the adapt a user interface at the user device for capturing input data content.

At 422 the captured input data may be received by way of the capture system, for example images characterizing objects, text data, or images characterizing one or more scenes or environments.

At 424 the capture system may make use of the semantic engine to perform real-time analysis of captured input data or content. The capture system may, at 426, output selectable options for performing one of any available type of data extraction (e.g., image processing, optical character recognition (OCR), or spatial data analysis or conversion). At 428, a selection of the data extraction option may be received at the capture system and at 430 the capture system may be configured to perform the processing and conversion of the captured input data or content in accordance with the selected data extraction option. The capture system may use the clipboard application to integrate the processed input data or content into the clipboard application at 432, and the capture system may be configured, at 434 to store the processed, or the original raw input data or content captured for future extraction.

Some examples, such as at 436 to 440 of the described process 400 of FIG. 4, may be configured to provided extended reality support. In such cases, the capture system may, at 436, be configured to use the accessed domain intent to select a relevant extended reality content. At 438 the capture system may be configured to use the clipboard application to display the extended reality content based on the accessed domain intent. At 440, the capture system may adapt the extended reality content based on one or more input commands indicated from the user, such as indicating user activity. At 442, an option may be provided to transfer, by the user device, to the clipboard service (for example comprising a clipboard server), resulting adapted input data based on the associated domain or active intent.

It will be understood that various modifications may be made to process 400 in accordance with the present disclosure. For example, the steps of the process 400 may be performed in any suitable order.

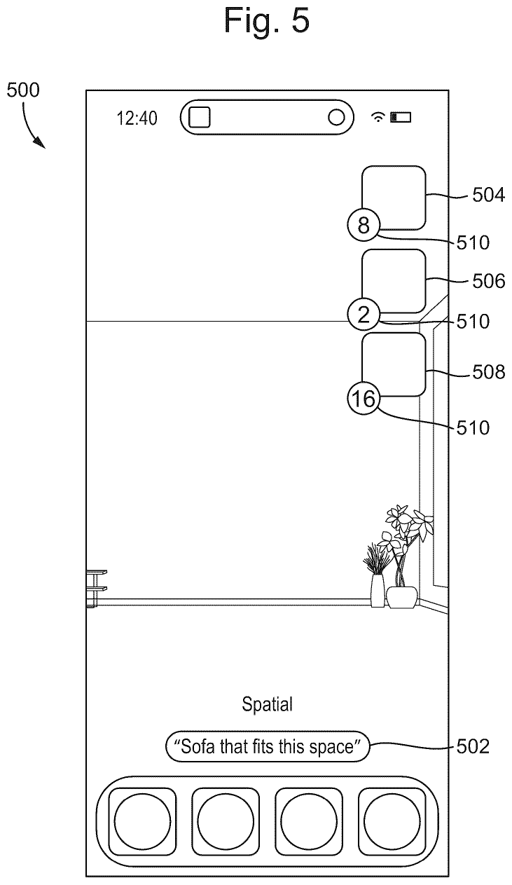

FIG. 5 shows an example display screen 500 of a user device, displaying a step of an example process in accordance with the present disclosure, in which at the display screen 500 of the user device there is displayed a text indication 502 of a determined active intent. In the example 500 shown, the text indication 502 of the active intent is the result of a determination of an active intent from input data received at the user device. In the example 500 of FIG. 5, the input data received at the user device, on which the active intent determination was performed, comprises an audible command received at a microphone (not shown) of the user device, and spatial image data obtained from a camera (not shown) of the user device. As can be seen from the display screen 500, the camera of the user device is activated in “spatial” mode for receiving spatial image data comprising three-dimensional information having a depth component. The audible command was processed using semantic processing as described herein to derive the active intent associated therewith, and to provide the text indication 502 shown. As can be seen from the text indication 502, the active intent in the time instance represented in FIG. 5 is “Sofa that fits this space”. In some examples, such as that shown, the determined active intent may be used to select an operating mode of one or more sensors, such as for capturing further input data. In the example shown, the determined active intent is used, for example by way of semantic processing, to determine that the operating mode of the camera of the user device should be the “spatial” imaging mode, for receiving the spatial image data associated with the task of determining a sofa which fits the space. The current operating mode may therefore be determined and, of the current operating mode is not the determined mode (e.g., “spatial” imaging mode), the current mode may be changed to the determined mode. In some examples, it will be appreciated that the operating mode of the one or more sensors may be determined manually, for example following receipt of input commands from a user. Following the accessing of domain intents associated with a plurality of applications stored for execution on the user device, a comparison of the active intent and the domain intents resulted in the determination of three applications 504, 506, 508 on the user device having domain intents relevant to the determined active intent. Examples will be appreciated wherein it may be determined that one or more of the plurality of applications are not stored for execution on the user device. In some such examples, the one or more applications may be determined for accessing and storing for execution on the user device. Therefore, in examples wherein the user device does not comprise one or more applications having domain intents relevant to the determined active intent, the one or more relevant applications may be sourced for accessing or storing on the user device, for example following corresponding input commands received from a user, or automatically. Examples will be appreciated wherein the determination of the one or more applications may comprise a bidding or auction by the one or more applications, such as based on the determined active intent.

In the example shown, the spatial image data was used to perform an initial query operation using each of the determined applications, the query generated based on the active intent and the spatial image data. As can be seen on the display screen 500 of FIG. 5, an interactive element 504, 506, 508 is displayed associated with each of the determined applications (such as based on the active intent, the corresponding application domain intent, and optionally the result of any application bidding or auction process), each interactive element configured to select the corresponding application (for example by way of deeplinking) for execution of the application, or an operation thereof, on the user device, following detection of an interaction therewith. As can be seen on the display screen 500, a preview 510 of the results of each query is displayed adjacent the corresponding interactive element 504, 506, 508 of the application from which the query results were obtained. In the example 500 shown, the preview 510 comprises a number of query results (for example sofas suitable for fitting the intended space) obtained using the corresponding application. In examples implementing deeplinking, an interaction with an interactive element may be configured to initiate a deeplink to a function or operation of the application, and may in some examples cause execution of the function or operation using one or more parameter presets defined by the deeplink, by the active intent, or by the input data. In the example 500 shown, an interaction with an interactive element 504 may cause a deeplink to the execution of the query using the corresponding application. In the example 500 shown, the interaction with the interactive element 504 may therefore cause the output of the of the results (8 sofas) of the query corresponding to the preview query results 510. In some examples, it may be determined that the application is not stored for execution on the user device. In such examples, interaction with the corresponding interactive element may cause the user device to access and store the corresponding application for execution on the user device, for example by way of an application database or server. In some such examples, interaction with the corresponding interactive element may execute an application storefront by way of which the corresponding application may be accessed for storage on the user device, such as by way of the application database or server.

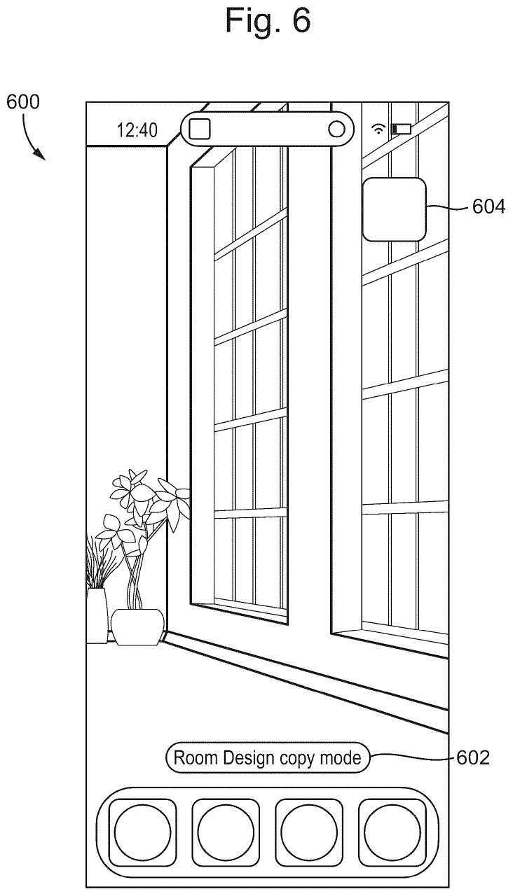

FIG. 6 shows an updated display screen 600 of the user device described in relation to FIG. 5, the display screen 600 updated following detection of further interaction with the user device, the further interaction providing input data associated with input commands. In the example 600 shown the input commands received were used to determine an active intent of “Room Design Copy Mode”, which can be seen displayed as a text indication 602 on the display screen 600. Such input commands may, for example, be associated with the selection of a function of an application, the selection detected as input data for informing the determination of the active intent. In the example 600 shown, the input commands may be associated with highlighting or otherwise marking regions of image data, which may be stored or live-feed image data obtained from a camera of the user device. The highlighting or marking of the regions of the image data may be used to determine the active intent of associated with “Room Design Copy Mode”, which may be determined to correspond to a domain intent of an application 604. The detection of relevant domain intent of the application 604 is used in the example 600 shown to display an interactive element 604 associated with the determined application. A detection of an interaction with the interactive element 604 may, based on the active intent, cause the performing of an associated operation, for example identifying one or more products associated with the highlighted or marked regions, using the application.

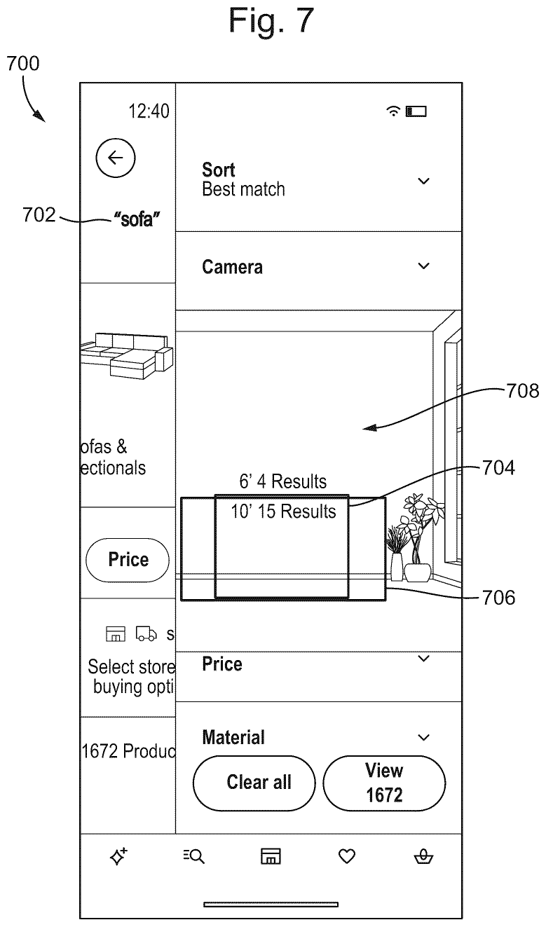

FIG. 7 shows an updated display screen 700 of the user device described in relation to FIG. 5 and FIG. 6, the display screen 700 updated following detection of further interaction with the user device, the further interaction providing the text input “sofa” 702, and spatial image data captured of a room. In the example 700 shown, the input data received was used to determine an active intent of “sofas to fit this space”. Upon determining only a single application stored for execution on the user device having a registered domain intent relevant to the determine active intent, using processes described herein, a query is automatically generated based on the input data and the active intent, and a search operation is automatically performed used the single application. The display screen 700 shown displays the result of the automatic performing of the operation, and in particular displays a preview of the query results 704, 706 overlaid on the image data 708 of the room. The two query results 704, 706 provide results of distinct queries performed based on spatial dimensions obtained from the spatial image input data. In particular, a first preview 704 indicates a number of query results available meeting a first dimension criteria (6 foot sofas) and a second preview 706 indicates a number of query results available meeting a second dimension criteria (10 foot sofas). In the example 700 shown a detected interaction with one of the previews 704, 706 may cause the application to either perform the associated query, or to display the full results of the associated query on the display screen 700. While the example 700 shown indicates only a single application stored for execution on the user device having a registered domain intent relevant to the determined active intent, one or more further applications, not stored for execution on the user device, may be determined. In some such examples, output of, and interaction with, a corresponding interactive element may cause the user device to access and store the one or more further applications for execution on the user device, for example by way of an application database or server. As such, interactive elements may be output for applications not stored on the user device (for example based on the active intent and the corresponding application domain intent), and may be used to access and store the corresponding applications for execution on the user device for performing methods of the present disclosure. The one or more further applications, and optionally the output or positioning of corresponding interactive elements associated therewith, may be determined, for example, at least in part by way of an application bidding or auction process. In some examples, any suitable visual characteristic of an interactive element, such as size, shape, color, spatial positioning, clarity or resolution, may be determined at least in part as a result of the application bidding or auction process.

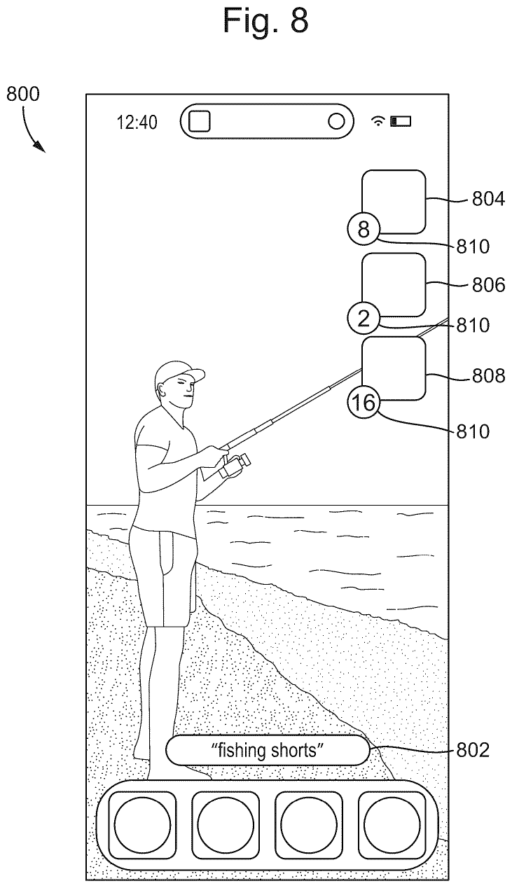

FIG. 8 shows an example of a further display screen 800 of a user device similar to that described in relation to FIG. 5, FIG. 6 and FIG. 7. The display screen 800 in the example shown displays a step of an example process in accordance with the present disclosure, in which at the display screen 800 of the user device there is displayed a text indication 802 of a determined active intent. In the example 800 shown, the text indication 802 of the active intent is the result of a determination of an active intent from input data received at the user device. In the example 800 of FIG. 8, the input data received at the user device, on which the active intent determination was performed, comprises an audible command received at a microphone (not shown) of the user device, and image data obtained from a camera (not shown) of the user device. The audible command was processed using semantic processing as described herein to derive the active intent associated therewith, and to provide the text indication 802 shown. As can be seen from the text indication 802, the active intent in the time instance represented in FIG. 8 is “fishing shorts”. Following the accessing of domain intents associated with a plurality of applications stored for execution on the user device, a comparison of the active intent and the domain intents resulted in the determination of three applications 804, 806, 808 on the user device having domain intents relevant to the determined active intent of “fishing shorts”. The audible command in the example shown was used in a semantic segmentation of the input image data, which was processed using suitable image processing techniques as described herein, to identify and characterize instances of “fishing shorts” in the image. For example, the individual depicted in the input image data can be seen holding a fishing rod, and wearing shorts. A semantic segmentation may therefore identify the fishing rod and the shorts, and may as a result determine that the shorts are fishing shorts. The resultant characterization of the instances of fishing shorts in the image data, which may for example include extraction of one or more visual characteristics or features, such as size, shape, colour, and texture, were used in the example shown to perform an initial query operation using each of the determined applications, the query generated based on the active intent. As can be seen on the display screen 800 of FIG. 8, an interactive element 804, 806, 808 is displayed associated with each of the determined applications, each interactive element configured to select the corresponding application (for example by way of deeplinking) for execution of the application, or an operation thereof, on the user device, following detection of an interaction therewith. As can be seen on the display screen 800, a preview 810 of the results of each query is displayed adjacent the corresponding interactive element 804, 806, 808 of the application from which the query results were obtained. In the example 800 shown, the preview 810 comprises a number of query results (for example fishing shorts having visual characteristics associated with those determined from the instances of fishing shorts identified in the input image data) obtained using the corresponding application.

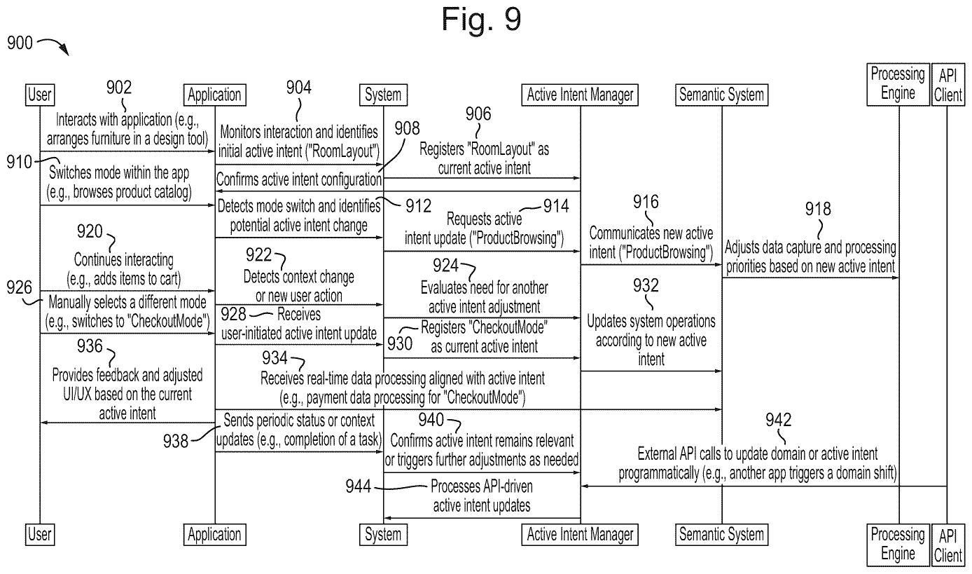

FIGS. 9 to 15 provide further examples of a system or method suitable for use in accordance with the present disclosure. Elements of the system or method in the examples of FIGS. 9 to 15 are labelled based on their function for clarity, but it will be appreciated that these elements may be comprised within any suitable module or functionality of a processing device or separated across multiple processing devices. It will therefore be appreciated that the functionality of one or more said elements may in some examples be combined in a single device, or separated across a plurality of devices in any suitable combination.

FIG. 9 shows a sequence diagram detailing steps of an example process 900 used for implementing a context-aware clipboard in accordance with the present disclosure, suitable for use with the system of FIG. 1 to FIG. 2, and in accordance with the method 300 of FIG. 3.

In particular, the steps of the process 900 may make use one or more of elements of a system 200 as described in relation to FIG. 2. In particular, the process 900 makes use of an application, for example a clipboard application, a camera application or a digital assistant, a user device or system, an active intent manager, a semantic system, a processing engine and an API client. It will be appreciated that the system elements used in the implementation of FIG. 9 may be any suitable elements which are located either locally to a user device or remote by way of one or more servers, or any combination thereof.

At 902, an interaction may be detected, for example from a user interacting with the application (e.g., arranging furniture in a design tool). At 904, the application may interact with elements of the user device or system to monitors indications of interaction from the user, and may, in response to the user interactions, determine an initial active intent (for example, “RoomLayout”). At 906, the user device or system may registers the determined active intent (e.g, “RoomLayout”) with the active intent manager, as the current active intent. At 908, in response to the registration, the active intent manager may provide a confirm of the registration of the current active intent. At 910, interaction may be received indicating a switching of application modes, such as between more than mode of operation of an application or between applications (e.g., to browse a product catalog). At 912, the application may detects the mode switch in response to the interactions and may identify, based on detected interactions associated with the mode switch, a potential active intent change. At 914, The user device or system may request, based on the potential active intent change, the active intent manager to update of the currently registered active intent (to, for example “ProductBrowsing”). At 916, the active intent manager may communicate the updated active intent to the semantic system (for example, “ProductBrowsing”). At 918, the semantic system may engage the processing engine to adjusts input data capture and processing priorities based on the updated active intent. At 920, continued indications of interactions may be received at the application associated with the process of browsing products (e.g., adding items to cart). At 922, the application may detect at the user device or system a context change or new user action, for example associated with proceeded to a checkout. At 924, the user device or system may engage the active intent manager to evaluate a need for a further adjustment of the active intent. At 926, the active intent manager may be actively engaged, for example by way of the semantic system, to select a different operating mode based on the continued interactions and input commands received (e.g., switches to “CheckoutMode”). At 928, the application may receive the user-initiated active intent update, and at 930, the application may output to the user confirmation of the update of the active intent registration (for example to “CheckoutMode”). At 932, the application may engage the user device or system to update system operations according to the new active intent, such as active processing operations or available input and interaction options. At 934, the user device or system may engage the active intent manager to communicate real-time data processing which aligned with the current active intent (e.g., payment data processing for “CheckoutMode”). At 936, the application may output any appropriate indication or feedback such as an adjusted user interface based on the current active intent and the associated available interactions and input options. At 938, the application may engage the user device or system to communicates periodic input data, or interaction indications, optionally as status or context updates (e.g., indications of completion of a task, such as the checkout task). At 940, the user device or system may engage the active intent manager to confirm that, based on the communications, either that the active intent remains relevant to the current input data or interactions, or triggers a further adjustment to the active intent. At 942, an external API may communicate an updated domain intent or active intent programmatically (for example if another application of the user device triggers a domain intent adjustment). At 944, the active intent manager may engage the user device or system to processes any API-driven active intent updates as a result of the communication.

In relation to the example of FIG. 9, the system may continuously monitor user interactions within the application and may identify events or conditions that necessitate an active intent adjustment. These triggers might include, but are not limited to, mode switches within the application, interactions with particular features or tools, or contextual changes recognized by the system. For example, in a home design application, the active intent might initially be set to “RoomLayout” while the user arranges furniture. If the user then switches to a catalog to browse for new items, the active intent could dynamically adjust to “ProductBrowsing”, prompting the system to prioritize capturing and processing data related to product information and visual comparisons.

The dynamic active intent adjustment of the system may be useful for applications that serve multiple purposes or have distinct operational modes. For instance, a multifunctional application might support both design and shopping tasks. As the user shifts between these tasks, such as moving from arranging furniture to finalizing a purchase, the system may update the active intent from “DesignMode” to “CheckoutMode”.

As the user shifts between these tasks, such as moving from arranging furniture to finalizing a purchase, the system can update the active intent from “DesignMode” to “CheckoutMode” While the camera functionality might be less relevant in “CheckoutMode” in some instances, the system may ensure that the captured data from previous intents remains accessible and optimized for the current task, such as by focusing on spatial data and style matching during design tasks, and then on seamless integration with payment systems during checkout tasks. In addition to automatically detecting context changes, the system may support user-initiated active intent adjustments. Users could explicitly switch an applications focus by selecting different modes or functions within the application, such as toggling between design and shopping interfaces for example. This capability may allow the user to direct the focus of the system based on their immediate needs, which may act to enhance the adaptability of an application.

The system may provide a dedicated API which applications may be configured to use to update their domain and active intent programmatically. For example, the API may be called when the user selects a new mode or tool, allowing the system to reconfigure its operations in real-time based on the updated active intent.

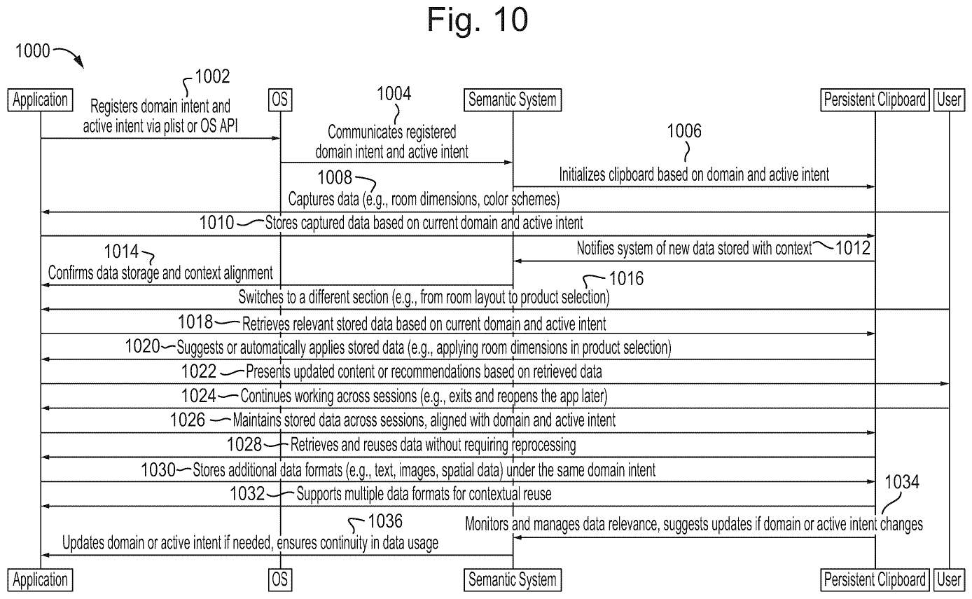

FIG. 10 shows a sequence diagram detailing steps of an example process 1000 used for implementing a context-aware clipboard in accordance with the present disclosure, suitable for use with the system of FIG. 1 to FIG. 2, and in accordance with the method 300 of FIG. 3.

In particular, the steps of the process 1000 may make use one or more of elements of a system 200 as described in relation to FIG. 2. In particular, the process 1000 makes use of an application, for example a clipboard application, a camera application or a digital assistant, an operating system of a user device, a semantic system, and a persistent clipboard (such as a clipboard server). It will be appreciated that the system elements used in the implementation of FIG. 10 may be any suitable elements which are located either locally to a user device or remote by way of one or more servers, or any combination thereof.

At 1002, the application may engage the operating system to register a domain intent and optionally one or more active intents associated with the application, for example any functions or operations thereof (e.g., via a properties list (plist) or an OS API). At 1004, the operating system may be configured to engage the semantic system to communicate the registered domain intent and optionally the one or more active intents. At 1006 the semantic system may initializes the persistent clipboard based on the domain intent and the one or more active intents. At 1008, input data may be captured by the user device, for example the application operating thereon. The captured input data may be any suitable data (e.g., room dimension data, color scheme data). At 1010, the persistent clipboard may be accessed or engaged to store the captured input data, for example based on a current domain intent and/or a current active intent. At 1012, the persistent clipboard may engage the semantic system with a communication indicating the input data stored with the active and domain intents. At 1014, the semantic system may confirm the storage of the input data by way of an output message, which may be received at the application and may be displayed for example at a display screen of the user device. The output message may also confirm the alignment of the input data with an active intent or domain intent. At 1016, indication of input commands or interaction may be received associated with switching to a different section of an application (e.g., from room layout to product selection). At 1018, the application may engage the persistent clipboard to retrieve relevant stored input data based on the current active intent and domain intent. At 1020, the persistent clipboard may suggest by way of the application, or automatically apply, stored data at the clipboard to an operation performed at the application (e.g., applying room dimensions in product selection). At 1022, the application may output, for example by way of a display screen, updated application content or recommendations based on retrieved input data. At 1024 continued interaction and input commands may be received as a user continues working across one or more application sessions (e.g., exits and reopens the app later). At 1026, the application may engage the persistent clipboard to maintain stored input data across multiple application sessions, the stored input data maintained on the clipboard aligned with the current active intent and domain intent. At 1028 the persistent clipboard may retrieve and reuse, by way of the application, input data without requiring reprocessing. At 1030 the application may engage the persistent clipboard to stores additional input data which may comprise multiple data formats (e.g., text, images, spatial data) relevant to the same active or domain intent. At 1032 the persistent clipboard may engage the application to support the storage and accessing of input data of multiple data formats for reuse relevant to the active or domain intent. At 1034, the persistent clipboard may engage the semantic system to monitor and manage input data relevance (for example input data stored at the clipboard or newly input data), and may instruct an updating of the active intent or domain intent if a new active or domain intent is determined. At 1036, the semantic system may engage the application to update the active intent or the domain intent based on continued input data, interactions and input commands, and may ensure continuity in data usage.

Referring to the example of FIG. 10, the system may in some examples introduce a persistent and context-aware clipboard feature combined with the concept of “domain intent” and “active intent” registration by applications. Each application may in some examples define and register a corresponding domain intent (and optionally an active intent), such as a furniture shopping application, in “room layout” mode, a home design planner, or a document editor. The defining and registering of the intents associated with the application may be performed by any suitable method, and may, for example, be through an application properties list (plist) of the application, or by way of an operating system API. The domain intent and active intents may be communicated to the operating system and the semantic system, enabling the system to tailor data capture, processing, and integration according to the specific needs and context of the application.

A persistent clipboard may in some examples be designed to store and manage data based on a user's ongoing activities within a single application, retaining relevant data across multiple sessions rather than overwriting content with each new copy operation. For example, when a user captures data within a furniture shopping app, such as room dimensions or color schemes, the clipboard may retains the data for future use within the same application. The system may automatically suggest or apply the data in relevant contexts within the application, such as when the user navigates between different sections of the application. The clipboard may, in some examples, also support the storage of multiple data formats simultaneously, which may enable the user to access and reuse text, images, and spatial data as needed without requiring reprocessing. Such examples may enhance efficiency of data management and reuse within the scope of a single application, and may thereby improve workflow continuity and reducing redundant processing.

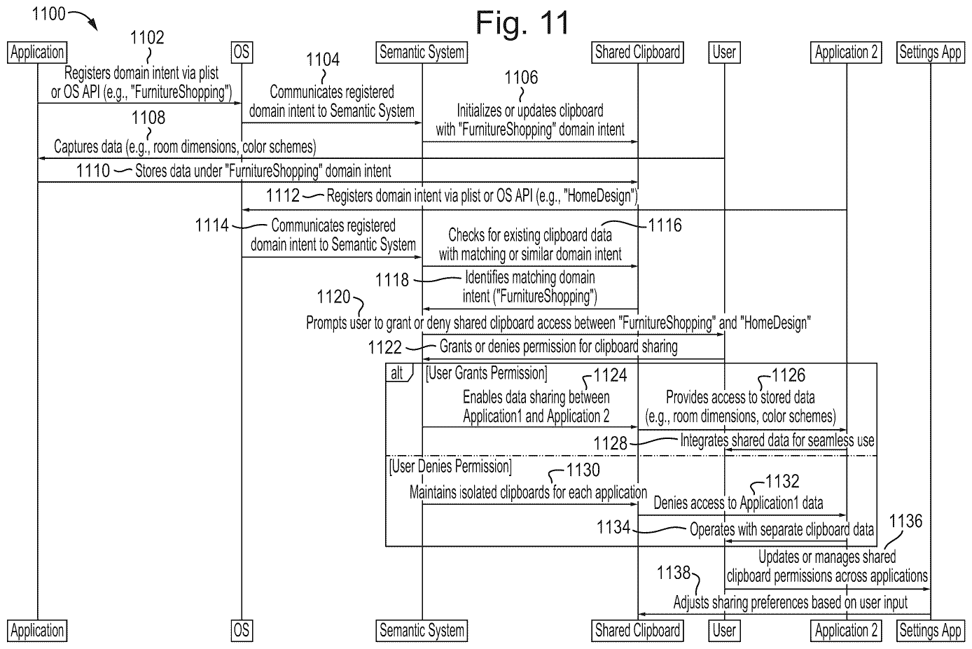

FIG. 11 shows a sequence diagram detailing steps of an example process 1100 used for implementing a context-aware clipboard in accordance with the present disclosure, suitable for use with the system of FIG. 1 to FIG. 2, and in accordance with the method 300 of FIG. 3.

In particular, the steps of the process 1100 may make use one or more of elements of a system 200 as described in relation to FIG. 2. In particular, the process 1100 makes use of a first application, for example a clipboard application, a camera application or a digital assistant, an operating system of a user device, a semantic system, a shared clipboard (such as a clipboard server), a second application and a settings application. It will be appreciated that the system elements used in the implementation of FIG. 11 may be any suitable elements which are located either locally to a user device or remote by way of one or more servers, or any combination thereof.

At 1102, the first application may engage the operating system of the user device to register a domain intent of the application (e.g., via plist or OS API) for example associated with operation or function thereof (e.g., “FurnitureShopping”). This may in some examples be performed automatically, for example following a downloading, storing or first execution of the first application on the user device (for example from an application storefront). At 1104, the operating system may communicate the registered domain intent to the semantic system. At 1106 the semantic system may be configured to initialize or update the shared clipboard with the “FurnitureShopping” domain intent. At 1108, input data may be captured and received at the user device (e.g., the input data comprising room dimensions, and color schemes). At 1110, the first application may access the shared clipboard to store the captured input data associated with active intent or a domain intent (e.g. “FurnitureShopping”). At 1112, a second application may, by way of the operating system, register a corresponding domain intent (e.g., via plist or OS API) for example associated with an operation or function thereof (e.g., “HomeDesign”). At 1114, the operating system may communicate the registered domain intent of the second application to the semantic system. At 1116, the semantic system may access the shared clipboard and confirm the presence of existing input data stored at the clipboard, the input data having an associated active or domain intent. At 1118, the shared clipboard may, using the semantic system, identify that a domain intent from among the registered domain intents matches, or comprises a acceptable similarity to, the active or domain intent associated with the input data (e.g., “FurnitureShopping”). At 1120, the semantic system may be configured to output, by way of a display screen for example, a prompt for instruction from the user to grant or deny shared input data access between the two domain intents “FurnitureShopping” and “HomeDesign”, or between the first and second applications. At 1122, an instruction or input command may be received granting or denying the permission for clipboard sharing between applications or domain intents.

In instances wherein the user grants permission, at 1124 the semantic system may engage the shared clipboard to enables input data sharing between the first and second applications. At 1126, the shared clipboard may provide access to the stored input data (e.g., room dimensions, color schemes) for use within the second application. At 1128, the second application may integrate the shared input data in operations thereof, for seamless use.

In instances wherein the user denies permission, at 1130, the semantic system may cause the shared clipboard to maintain the input data associated with the first application and the second application in corresponding isolated clipboards. At 1132, the shared clipboard may deny the second application access to input data associated with the first application. At 1134, the second application may continue operation using and accessing separate clipboard data to the input data associated with the first application. At 1136, the user may at any time update or manage, by way of a settings application or operation of the shared clipboard, the shared clipboard permissions across one or more, or all, applications. At 1138, the settings application may adjust input data sharing preferences based on the user input.

Referring to the example of FIG. 11, the example introduces a domain intent-based shared clipboard which may enhances data interoperability across multiple applications with similar or related purposes. Each application of a plurality of applications may define and register a corresponding domain intent, such as furniture shopping, home design, or document editing, with the system through the corresponding application properties list (plist) or an operating system API. When an application registers its domain intent, the system may identify whether other applications have already registered the same or a similar domain intent. If another application with a matching or similar domain intent exists, the system may prompt the user to grant or deny permission for shared clipboard access between these applications.

For example, if a user captures room dimensions and color schemes within a furniture shopping application, and then opens a home design planner application which requests the same domain intent, the system may submit a request for instructions, for example from the user, on whether to allow the new application to share the existing clipboard data. If the instructions are received, for example if user consents, the clipboard data may become accessible to each of the corresponding applications, which may allow seamless data integration and reuse. If instructions or not received, or if the instructions received indicate that no permission is to be granted, for example, if the user denies permission, each application may maintain a corresponding isolated clipboard, which may ensure that associated input data remains separated. Such sharing preferences may also persist and be updated in a settings application.

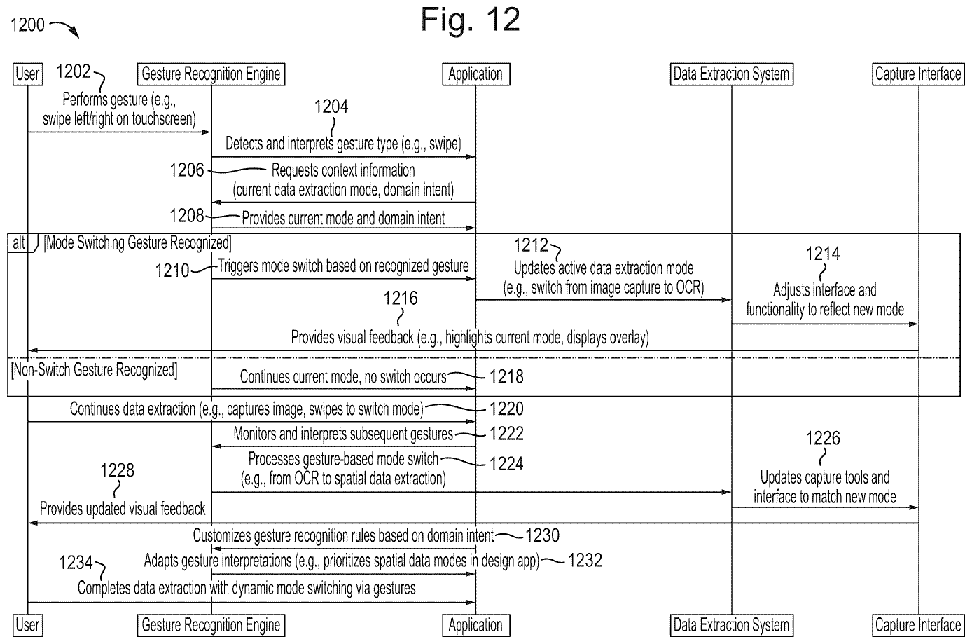

FIG. 12 shows a sequence diagram detailing steps of an example process 1200 used for implementing a context-aware clipboard in accordance with the present disclosure, suitable for use with the system of FIG. 1 to FIG. 2, and in accordance with the method 300 of FIG. 3.

In particular, the steps of the process 1200 may make use one or more of elements of a system 200 as described in relation to FIG. 2. In particular, the process 1200 makes use of an application, for example a clipboard application, a camera application or a digital assistant, a gesture recognition engine, a data extraction system, and a capture interface. It will be appreciated that the elements used in the implementation of FIG. 12 may be any suitable elements which are located either locally to a user device or remote by way of one or more servers, or any combination thereof.

At 1202, input commands or interaction may be received at the gesture recognition engine associated with perform a gesture (e.g., swipe left/right on a touchscreen of a user device). At 1204 the gesture recognition engine may, by way of the application, detect and interpret the gesture type (e.g., swipe) of the input gesture. At 1206, the application may request at the gesture recognition engine, context information associated with the gesture, for example a current data extraction mode, a current active intent or a current domain intent. At 1208, the gesture recognition engine may provide to the application, in response to the request, the context information (e.g., the current input data extraction mode, the current active intent, the current domain intent).

In instances wherein a gesture is recognized by the gesture recognition engine associated with mode switching, at 1210 the gesture recognition engine may, by way of the application, trigger a mode switch thereof (for example an operating mode, such as a current data extraction mode) based on the recognized gesture. At 1212, the application may, by way of the data extraction system, and based on the trigger, update the current data extraction mode (e.g., switch from image capture to optical character recognition (OCR)). At 1214, the data extraction system may, by way of the capture interface, adjust the interface and functionality thereof to reflect the updated input data capture mode. At 1216, the capture interface may provide any suitable visual feedback by way of output to a user reflecting the change in the current input data capture mode (e.g., by highlighting the current data capture mode or providing an associated display overlay).

In instances wherein a gesture is recognized by the gesture recognition engine which is not associated with mode switching, at 1218, the gesture recognition engine may, by way of the application, continue to operate based on the current input data capture mode, and no switch occurs.

At 1220, the process 1200 continues with instructions and input commands received associated with continued data capture and extraction in accordance with the current input data capture mode (e.g., capturing images and using swipe gestures to switch modes). At 1222, the application, by way of the gesture recognition engine, may monitors and interpret subsequent gesture inputs. At 1224, the gesture recognition engine may, by way of the data extraction system, process a gesture-based current input data capture mode switch or a current input data extraction mode switch (e.g., from OCR to spatial data extraction). At 1226, the data extraction system may engage the capture interface to update one or more capture tools and interface elements to match the new mode as a result of the switch. At 1228, the capture interface, such as elements thereon, may output or provide updated visual feedback representing the mode switch. At 1230 the application, by way of the gesture recognition engine, may customize one or more gesture recognition rules based on a current active intent or a current domain intent. At 1232, the gesture recognition engine may, by way of the application, adapt gesture interpretations based on the customized one or more gesture recognition rules (e.g., prioritizes spatial data modes in design app). At 1234, the user may continue and complete input data extraction using dynamic mode switching via gestures.

Referring to the example of FIG. 12, a system may be provided configured to use gesture recognition to enhance the receipt of interaction or input commends, for example by way of user interaction, by enabling seamless mode switching during input data extraction processes. Such examples may allow users to intuitively navigate between different data extraction modes, such as image capture, optical character recognition (OCR), and spatial data extraction, through the use of one or more predefined gestures, thereby eliminating the need to access traditional menus or interfaces. The system may, in some examples, be configured to recognize a range of input gestures, such as performed by the user on a touchscreen interface or any other suitable input device. In some examples, a gesture may comprise a swipe gesture of a plurality of swipe gestures, such as a left or right swipe across a touchscreen. The gesture may, following detection, be used to cycle through various input data extraction modes. When an indication is received that the gesture has been performed, for example by the user on a touchscreen, the system may dynamically shift between the available input data extraction modes, for example updating a capture interface and associated functionality accordingly. Such real-time mode switching may enable the user to quickly adapt the behavior of the system to a required task without interrupting workflow.

The gesture-based interaction may be used in some examples wherein capturing of multiple types of data from a single source is required. For example, a user might begin by capturing an image of a document, then input a gesture or swipe to switch to an OCR mode, such as to extract and edit text within the image, followed by a further gesture or swipe configured to transition the input data extraction mode to spatial data extraction, for example if the document comprises diagrams or layout information. By recognizing and responding to such gestures, the system may streamline data extraction processes, and may for example reduce a number of input interactions required to be detected and processed, allowing for a more fluid and efficient process. To support such capabilities, the system may include a gesture recognition engine configured to monitor receipt of input data, for example from a touchscreen or other suitable sensor. The gesture recognition engine may in some examples be configured to distinguish between more than one gesture type, such as swipes, taps, and pinches. The gesture recognition engine may, in some examples, be configured to interpret the one or more gesture types, for example in the context of a current application state. The system may in some examples provide any suitable feedback, such as visual feedback, during the gesture interaction, for example by highlighting a current or active application mode or function, such as the current data extraction mode, or by displaying an overlay indicating the current or active application mode or function, thereby ensuring that the user remains aware of the operating status or mode of the application or system at all times and thereby reducing the number interactions and input for receipt and processing.

The gesture recognition system may in some examples be customized based on one or more domain intents associated with an application, or any specific requirements of a system or user. For example, in an architectural design application, the system may be configured to prioritize gestures which switch between spatial data extraction modes, while in a document management application, the system may be configured to prioritize toggling between image capture and OCR.

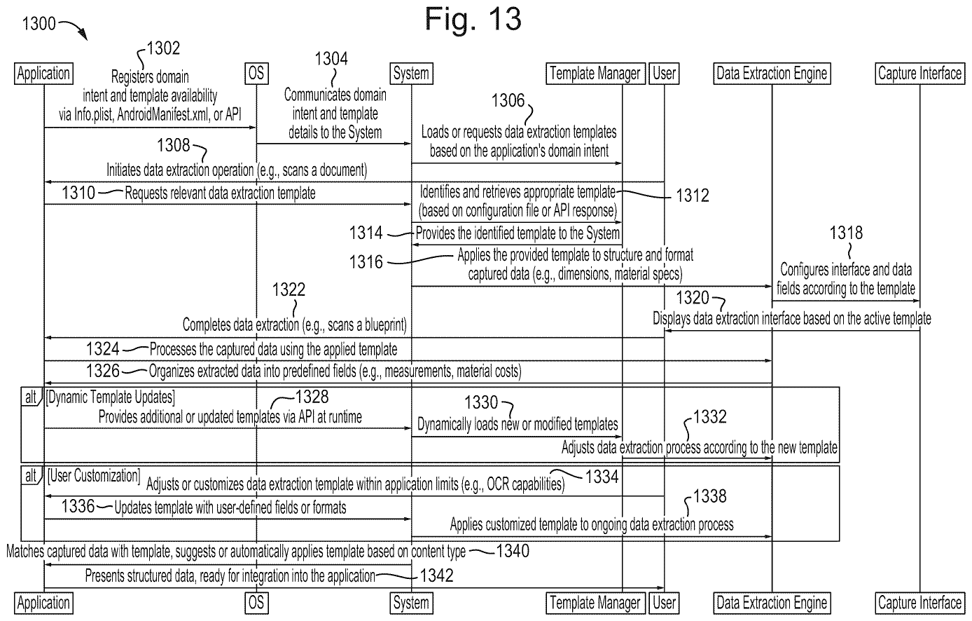

FIG. 13 shows a sequence diagram detailing steps of an example process 1300 used for implementing a context-aware clipboard in accordance with the present disclosure, suitable for use with the system of FIG. 1 to FIG. 2, and in accordance with the method 300 of FIG. 3.

In particular, the steps of the process 1300 may make use one or more of elements of a system 200 as described in relation to FIG. 2. In particular, the process 1300 makes use of an application, for example a clipboard application, a camera application or a digital assistant, an operating system of a user device, a user device or system, a template manager, a data extraction engine and a capture interface. It will be appreciated that the elements used in the implementation of FIG. 13 may be any suitable elements which are located either locally to a user device or remote by way of one or more servers, or any combination thereof.

At 1302, the application, by way of the operating system (e.g., via Info.plist, AndroidManifest.xml, or an API), registers a domain intent associated therewith, along with an availability of an input data template associated with an input data format accepted thereby. At 1304, the operating system may communicate the domain intent and the template details to the user device or system. At 1306, the system may, by way of the template manager, load or request data extraction templates based on the domain intent of the application. At 1308, a user may initiate, for example by away of the application, a data extraction operation (e.g., scans a document). At 1310, the application may request a relevant data extraction template by way of the template manager. At 1312, the system may, using the template manager, identify and retrieve an appropriate template (e.g., based on a configuration file or an API response). At 1314, the template manager may provide the identified template to the user device or system. At 1316, the user device or system may, by way of the data extraction engine, apply the provided template to structure and format captured input data (e.g., the dimensions or material specifications of the input data). At 1318, the data extraction engine may configure an output to the user, such as a user interface of a display screen of the user device, along with data fields, according to the template. At 1320, the capture interface may display the updated data extraction interface based on the active template. At 1322, instructions may be received, for example relating to interaction or input commands from the user, to completes the data extraction (e.g., scanning a blueprint). At 1324, the application may, by way of the capture interface, process the captured data using the applied template. At 1326, the capture interface may, by way of the application, organize the extracted input data into predefined fields according to the template (e.g., measurements and material costs).

In some cases, wherein the system is configured for dynamic template updates, at 1328, the application may provide additional or updated templates to the user device or system (e.g., via an API at runtime). At 1330, the system may, by way of the template manager, dynamically load a new or modified template. At 1332, the template manager, by way of the data extraction engine, may adjust input data extraction processes according to the new or modified input data template.

In some cases, wherein the system is configured for user customization, at 1334, input instructions may be received, for example from a user, to adjust or customize an input data extraction template, for example within predefined application limits (e.g., OCR capabilities). At 1336, the application may, by way of the user device or system, update the template with user-defined fields or formats. At 1338, the user device or system may, using the data extraction engine, apply the customized template to ongoing data extraction processes.

At 1340, the user device or system may, by way of the application, match captured input data with a template of a plurality of templates and instruct application of, or automatically apply, the template based on an input data or content type. At 1342, the application may output or display the input data structured in accordance with the template, for integration into the application.

Referring to the example embodiment of FIG. 13, the system may incorporate any suitable feature configured to permit applications to provide customizable data templates for use during the receipt or processing of input data, for example input data extraction. Such templates may be specific to an application or an input data type, and may in some examples be associated with, or stored alongside, the application based on a corresponding domain intent or a specific operation, function, mode or use case of the application. Such a feature may cause received (and optionally extracted) input data to be automatically formatted and structured according to the requirements of the corresponding application. Applications may provide such templates by way of any suitable process or mechanism, such as by way of associated configuration files, such as the Information Property List (Info.plist) in iOS, the AndroidManifest.xml in Android, or via an API configured to communicate with the system. For example, an application may include a predefined key in an associated configuration file specifying the location and details of an available templates. Alternatively, or additionally, the application may provide one or more templates dynamically at runtime, for example following an API call, which may allow for more flexible and context-specific template delivery. For example, a design application may be associated with, or provide, a corresponding template for extracting and organizing dimensions and material specifications from specific types of input data, such as architectural plans. Such templates may be defined within a configuration file of the application, and may detail any associated input data formatting or structuring requirements, such as specific data fields, formats, and rules required for accurate input data extraction. A research application may include one or more templates for extracting citations and references from academic papers, for example ensuring that the captured data aligns with the structured output required for a particular publication.

An input data extraction operation may be initiated by the application, for example following instructions received from a user. Upon initiation, or at any suitable time thereafter or therebefore, the system may be configured to automatically detect one or more relevant templates associated with the application. Such a detection may be performed, for example, by reading a file associated with the application, such as the configuration file of the application, or by accessing or receiving the templates by way of an API. The system may apply the appropriate template to format or structure the received or extracted input data in a way that makes the input data compatible with one or more data handling requirements of the application. For example, when a user scans a blueprint within a design application, the system may apply an associated architectural template, organizing the extracted data into predefined fields for dimensions, material types, and associated costs. In some examples, an application may permit altering or customization of one or more templates, for example by a user, such customization or altering optionally being limited or restricted only by the capabilities of an associated device on which the application is executed.

In some examples, the system may provide any suitable mechanism for automatically matching the captured or received input data with one or more templates, for example based on the input data, the application or any associated function or operation thereof, the active intent, or the domain intent. For example, when the received or captured input data comprises a construction document comprising measurements and material specifications, the system may be configured to recognize, detect or indicate relevant data types, and may be configured to suggest or automatically apply a corresponding template, for example a template associated with the design application. Such a matching process may streamline data extraction, and may ensure that received input data is consistently formatted according to the requirements of an application.

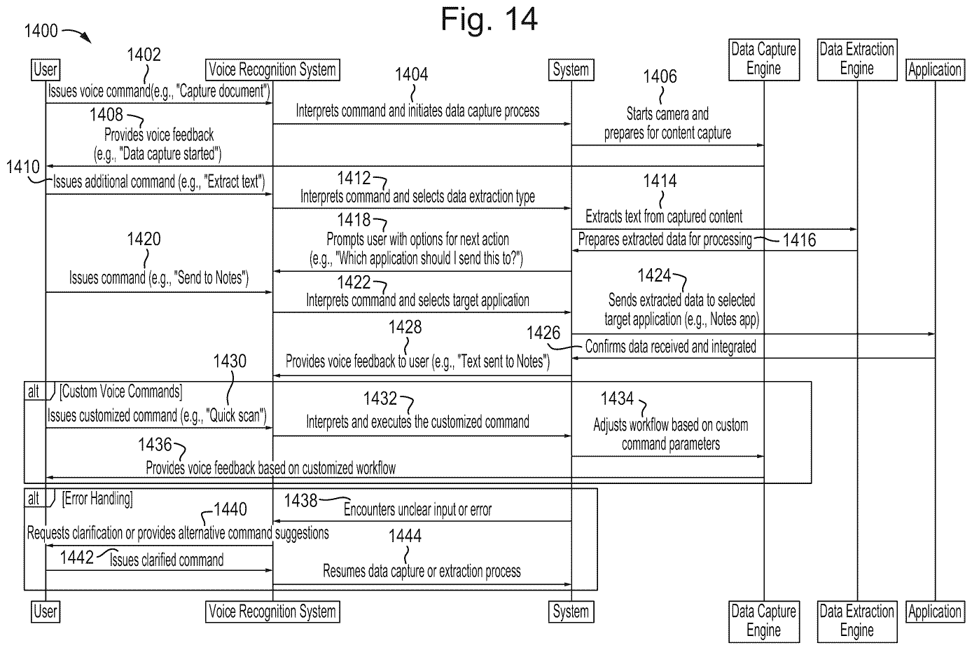

FIG. 14 shows a sequence diagram detailing steps of an example process 1400 used for implementing a context-aware clipboard in accordance with the present disclosure, suitable for use with the system of FIG. 1 to FIG. 2, and in accordance with the method 300 of FIG. 3.

In particular, the steps of the process 1400 may make use one or more of elements of a system 200 as described in relation to FIG. 2. In particular, the process 1400 makes use of an application, for example a clipboard application, a camera application or a digital assistant, an user device or system, a voice recognition system, a data capture engine, and a data extraction engine. It will be appreciated that the elements used in the implementation of FIG. 14 may be any suitable elements which are located either locally to a user device or remote by way of one or more servers, or any combination thereof.

At 1402, an input voice command may be received at the voice recognition system, for example from a user (e.g., the command, “Capture document”). At 1404, the voice recognition system may, by wat of the user device or system, interpret the voice command and initiate a data capture process. At 1406, the system may, using the data capture engine, initiate operation of a input data capture device of the user device or system, such as a camera, and prepare for input data content capture. At 1408, the data extraction engine may output, for example to the user by way of one or more speakers of the user device, voice feedback (e.g., the feedback, “Data capture started”). At 1410, a further voice command may be received (e.g., the voice command, “Extract text”). At 1412, the voice recognition system may, by way of the user device or system, interpret the further voice command and select an input data extraction type. At 1414, the system or user device may use the data extraction engine to extract text from the captured input data content. At 1416, the data extraction engine may, by way of the user device or system, prepare the extracted input data for further processing. At 1418, the system or user device may use the voice recognition system to output a prompt to the user, the prompt comprising options for a next action (e.g., a text or voice prompt of, “Which application should I send this to?”). At 1420, a further voice command may be received (e.g., the voice command “Send to Notes”). At 1422, the voice recognition system may, by way of the user device or system, interpret the further command and select a target application associated with the further voice command (e.g., Notes). At 1424, the system may, by way of the application, send extracted input data to the selected target application (e.g., Notes). At 1426, the application may, by way of the system, confirm that the input data was received and integrated. At 1428, the system may, by way of the voice recognition system, provides a further voice feedback to user, for example by way of speakers of the user device or system (e.g., the voice feedback, “Text sent to Notes”).

In some examples implementing custom voice commands, at 1430, a customized voice command may be received from the user (e.g., “Quick scan”). At 1432, the voice recognition system may, by way of the user device or system, interpret and execute the customized command. At 1434, the system may, using the data capture engine, adjust adjusts data capture workflow based on one or more custom command parameters associated with the custom command. At 1436, the data capture engine may output, for example by way of one or more speakers of the user device or system, voice feedback based on customized workflow.

In some examples implementing error handling, at 1438, the system may, by way of the voice recognition system, encounter an unclear input data or an error. At 1440, the voice recognition system may be configured to output, for example by way of a prompt to the user, such as a vocal prompt, a request for clarification or one or more alternative voice command suggestions. At 1442, a clarified command may be received by the voice recognition system, and at 1444, the voice recognition system resumes, by way of the user device or system, input data capture or extraction processes.

Referring to the example of FIG. 14, the system may incorporate voice command functionality, which may enable users to initiate and control input data receipt, capture and/or extraction processes using verbal instructions. Such a “hands-free” approach may act to enhance accessibility and convenience, particularly in scenarios where manual interaction with a user device is impractical or less efficient. In some examples, such a compatibility with voice commands may streamline workflow processes, thereby permitting a user to manage the entire input data receipt, capture and extraction process without needing to physically interact with the device. Reduced number of required interactions may reduce the number input commands required to be received and processed. The system may in some examples be configured to recognize any number of voice commands, for example a user may issue a voice command configured to, when received as input data, initiate the input data capture process. The input voice command may in some examples specify a type of input data to be expected, received, captured or extracted, such as images, text, or spatial data. The system may, in some examples, be configured to respond to one or more voice commands, for example for selecting a target application, processing captured or received input data, and copying the extracted input data content into a selected application.

The voice command functionality may be configured to be integrated with an existing voice recognition system, such as Siri on iOS or Google Assistant on Android, or may in some examples operate through a dedicated voice interface within an application. The system may in some examples be configured to receive one or more predefined commands associated with one or more corresponding common actions, such as “Start Capture”, “Extract Text”, or “Send to Document Editor”. The system may be further configured to receive instructions to customize one or more input commands, such as the voice commands, for example by a user to suit their preferences. The customizing of one or more input commands may for example allow creating shortcuts for frequently used tasks or adjusting a phrasing to match natural speech patterns. For example, in a document processing scenario, the system may be configured to receive the voice command, “Capture document”, to initiate the operation of a camera and begin scanning a page. The system may in some such examples, provide an output or prompt, for engagement by the user, the output or prompt comprising one or more options for input data extraction. Such a prompt may, in some examples, comprise a vocal prompt, output by any suitable device, for example a speaker. The output or prompt may, for example comprise a vocal prompt comprising speech, such as, “Would you like to extract text, images, or both?” After receiving or detecting an input response from the user of “Extract text”, the system may be configured to proceed with the input data extraction. In some such examples, the system may be configured to provided sequential prompting of the user for input instructions. In the specific example described, the system may output a vocal prompt comprising the speech, “Which application should I send this to?” Upon receiving or detecting an acceptable response input from the user, for example, “Send to Notes”, the system may be configured to automatically copy or paste the extracted input text into the appropriate application (which in the presently described example is the Notes application). Such a process may therefore be completed without requiring any manual input from a user. As described, the system may in some examples implement voice feedback, for example to confirm recognized input commands or to provide status updates throughout the process. For example, after capturing input data, the system may be configured to vocally announce, “Data captured successfully. Extracting text now”, which may optimally inform the user of the status of the system or process and actions being performed. In some examples wherein the system encounters one or more errors or issues, such as an unclear input command, or if a command is not recognized (for example by a voice recognition module of the system, the system may be configured to output one or more prompts to the user for clarification, or to provide suggestions for alternative input commands.

In some examples, the system may be configured to handle complex workflows involving multiple steps. For example, an input command may be received from a user working on a design project, the command determined by the system to be associated with capturing spatial input data, followed by further received input commands determined to be associated with extracting specific measurements from the spatial input data, and provide the measurements for use within a design application. The system may for example guide the user through one or more steps of the process, issuing outputs or prompts confirming actions performed during the process, and issuing outputs or prompts requesting additional inputs when required, while maintaining a hands-free operation of the process.

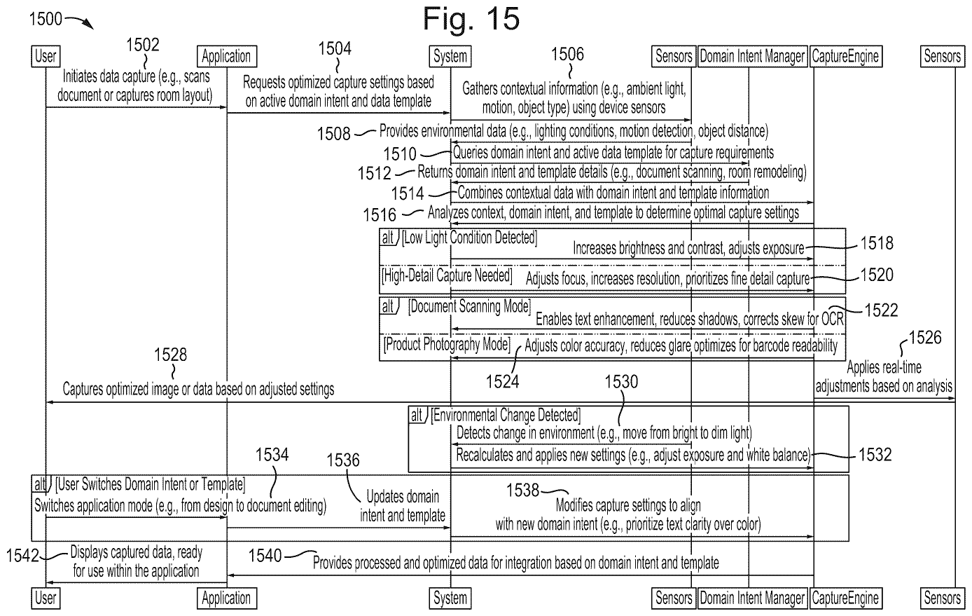

FIG. 15 shows a sequence diagram detailing steps of an example process 1500 used for implementing a context-aware clipboard in accordance with the present disclosure, suitable for use with the system of FIG. 1 to FIG. 2, and in accordance with the method 300 of FIG. 3.

In particular, the steps of the process 1500 may make use one or more of elements of a system 200 as described in relation to FIG. 2. In particular, the process 1500 makes use of an application, for example a clipboard application, a camera application or a digital assistant, a user device or system, one or more sensors of the user device or system, a domain intent manager, and a capture engine. It will be appreciated that the elements used in the implementation of FIG. 15 may be any suitable elements which are located either locally to a user device or remote by way of one or more servers, or any combination thereof.

At 1502, instructions may be received at the application, for example from a user, to initiates input data capture (e.g., scanning of a document or capturing of a room layout). At 1504, the application may, by way of the user device or system, request optimized input data capture settings based on an active domain intent and one or more input data templates. At 1506, the system may, by way of one or more sensors thereof, capture input data comprising contextual information (e.g., ambient light, motion, object type). At 1508, the sensors may, by way of captured input data, provide environmental data (e.g., lighting conditions, motion detection, object distance). At 1510, the system may issue a query, by way of the domain intent manager, a domain intent and active data template for input data capture requirements. At 1512, the domain intent manager may communicate the domain intent and the template details (e.g., document scanning, room remodeling). At 1514, the system may, using the capture engine, combine the contextual input data with the domain intent and the template information. At 1516, the capture engine may, by way of the user device or system, analyze a context, the domain intent, and the template to determine optimal capture settings.

In some examples wherein a low light condition is detected, at 1518, the system may be configured to use the capture engine to modify the capture settings, for example to increase a brightness and contrast, and increase or adjust exposure accordingly.

In some examples in which high detail input data capture is required, at 1520, the system may, using the capture engine, modify the capture settings, for example to adjust a focus, increase resolution, or any other suitable modification configured to prioritize fine detail capture.

In some examples implementing a document scanning mode, at 1522, the capture engine may be configured to, by way of the user device or system, modify the capture settings, for example to enable text enhancement, reduce shadows, corrects skew for OCR, or any other suitable modification configured to optimize document scanning.

In some examples implementing a product photography mode, at 1524, the system may, using the capture engine, modify the capture settings, for example to adjust color accuracy, reduce glare, optimize for label or barcode readability, or any other suitable modification configured to optimize product photography.

At 1526, the domain intent manager may be configured to apply real-time adjustments to the capture mode or capture settings based on analysis or assessment of input data, for example based on an active intent or a domain intent. At 1528, the capture engine may be used to capture optimized input data, for example image data, based on any of the modified capture settings described.

In some examples wherein an environment change is detected, at 1530, the sensors of the system may detects a change in an environment (e.g., move from bright to dim light), which may for example be based on captured input data, such as image data. At 1532, the system may be configured to recalculate capture settings and apply the new capture settings at the sensors or the capture engine (e.g., to adjust exposure and white balance).

In some examples wherein a user switches domain intent, an application mode, or an input data template associated with an application, at 1534, instructions may be received, for example from a user, to switches an application mode (e.g., from design to document editing). At 1536, the application may be configured to update the domain intent and any associated input data template in accordance with the switch in the application mode. At 1538, the system may, by way of the capture engine, modify one or more input data capture settings to align with new domain intent (e.g., prioritize text clarity over color). At 1540, the capture engine may provide processed and optimized input data for integration based on the domain intent and the input data template. At 1542, the application may be configured to output, for example at a display screen of a user device, captured input data for use within the application.

Referring to the embodiment of FIG. 15, the system may be configured to perform contextual awareness, for example to automatically adjust input data capture settings based on the environment, the input data being captured, the active intent, the domain intent, or a data template associated with an application. By combining real-time environmental analysis with an understanding of an active intent, domain intent, an operational purpose of an application or a specific template associated with an application, the system may be configured to optimize the input data receipt and capture processes, for example ensuring that an output of the process aligns with one or more requirements of an application, or a data structure or formatting defined by, or within, a template. Such examples may enhance the accuracy, quality, and relevance of the captured data without requiring user intervention.

In some examples, the system may be configured to gather contextual information using sensor data, which may in some examples be comprised within the input data, the sensor data obtained from one or more sensors of a device, for example a user device. In some examples, the sensor may be an ambient light sensor, an accelerometer, or a camera. Any suitable sensor will be appreciated with the context of the present disclosure. The sensor data may be processed to determine the contextual information, which may comprise processing the sensor data and the active intent or the domain intent, or one or more templates associated with an application. For example, if a domain intent is associated with document scanning, the system may be configured to prioritize text clarity, for example by automatically switching to a high-resolution capture mode, adjusting focus, or enabling any suitable text enhancement features. In examples wherein the application comprises, or is in, a mode focused on room remodeling or design, the system may be configured to adjust one or more input data capture or receipt settings, for example to capture finer details and more accurate colors, which may be based on one or more requirements of a template associated with the application, which may for example be designed for e-commerce product listings.

A capture engine within the system may be configured to process any suitable environment data, such as for example associated with lighting and motion. The environment data may in some examples be processed with, or based on, the active intent, the domain intent or one or more templates associated with an application, the template for example comprising one or more requirements for making real-time adjustments. For example, in low light conditions, the system may be configured to increase a brightness and contrast setting while receiving or capturing an image. Any suitable adjustments may be appreciated and may vary depending on specific use cases, such as an operating mode of an application. For example, an application may be operating in a mode configured for architectural design (where detail and accuracy may be prioritized), or for social media content creation (wherein other visual features may be prioritized). The system may in some examples be configured to determine when input data is being received or captured, for example the capturing of a document, and may be further configured to automatically apply one or more associated input data receipt, capture or extraction settings. For example, the system may be configured to determine when input data is being captured of a document, and may be further configured to automatically apply one or more input data extraction settings that align with OCR processing, such as reducing shadows and correcting skew, ensuring the text is suitable for extraction.

Additionally, the system may in some examples be configured to adapt, modify or adjust one or more operations or functions thereof based on an input data template for an application, which may define one or more input data capture, receipt or extraction requirements. For example, a template designed for extracting contact information from business cards may be configured to instruct the system to enhance text regions while minimizing background noise. A template designed for inventory management which focuses on extracting or organizing product details, such as barcodes, product names, serial numbers, quantities, and storage locations may be configured to prioritize the capture of barcode data, automatically adjust focus and zoom settings to ensure barcode readability, and enhance contrast to accurately capture text on labels, for example. The system may in some examples be configured to recognize the packaging of products and adjust the input data capture, receipt or extraction settings to process reflective surfaces, common on product packaging, for example to reduce glare and improve image clarity. By aligning the capture settings with one or more input data requirements or specifications of a template of an application, examples of the system may provide consistently formatted input or output data suitable for integration into an application.

The system may in some examples be configured to dynamically adjust one or more input data capture, receipt or extraction settings in response to changes in the environment, or the environment data, for example as a user switches between different active intents, domain intents or input data templates. For example, if the system detects a movement from a bright setting or environment, such as an outdoor setting or environment, to a dimly lit setting or environment, such as an indoor environment or setting, for example while capturing or receiving architectural details, the system may be configured to automatically determine and adjust one or more input data capture, receipt or extraction settings, such as exposure and white balance, to maintain image clarity. Similarly, if the user switches from a design mode to a document editing mode within the application, the system may be configured to modify one or more input data capture, receipt or extraction settings, for example to prioritize text recognition over color accuracy.

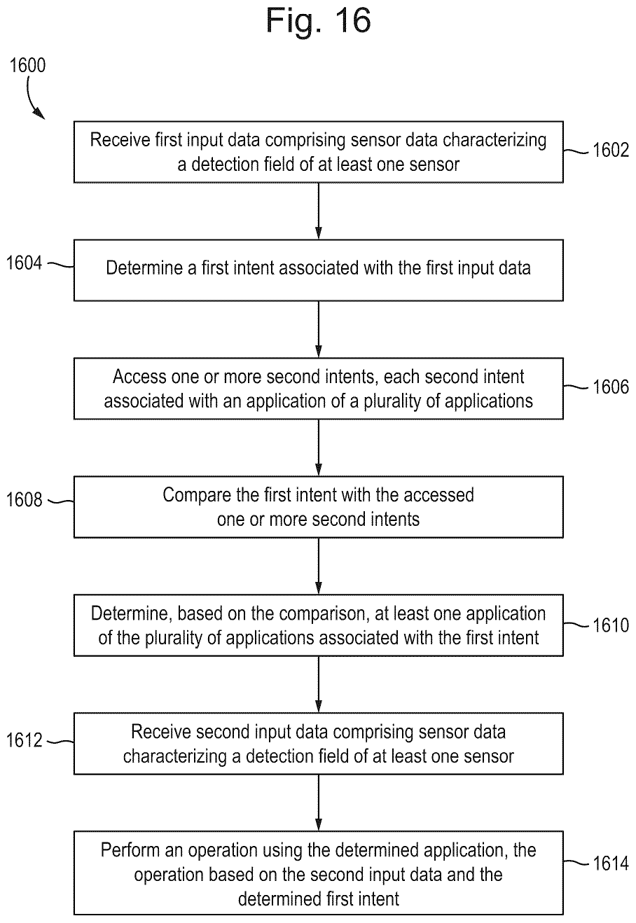

FIG. 16 shows a flowchart representing a further illustrative process 1600 for implementing a context-aware clipboard as an example alternative to that described in relation to the example 300 of FIG. 3. At 1602, the process comprises receiving first input data comprising sensor data characterizing a detection field of at least one sensor. The input data may be any suitable data and may include text or language data input by way of a text-input interface or by way of audio data, for example by way of a microphone. At 1604, the process 1600 comprises determining a first intent associated with the first input data. The determination of the first intent may for example include a semantic analysis of the input data, such as any text or language data comprised therein. Examples will be appreciated wherein a semantic context may be determined for any input data types, such as input image data, using any suitable semantic analysis method. Examples will be appreciated wherein the determination of the first intent may comprise non-semantic associated processing components, for example any suitable un-supervised processing or saliency analysis of image data.

At 1606, the process 1600 comprises accessing one or more second intents, each second intent associated with an application of a plurality of applications. The second intents may, for example, be associated with a broad operation, function or purpose of the associated application. The second intents may be stored or registered by an application at any suitable memory, and may for example be stored at an application sever associated with the application, or may be stored in data local to a user device, for example in metadata associated with the local storage of the application. An application having more than one function or functional purpose may comprise more than one second intent, each second intent associated with a corresponding one or more of the functions or functional purposes of the application.

At 1608, the process 1600 comprises comparing the first intent with the accessed one or more second intents. Any suitable comparison may be performed. The output or result of the comparison, which may for example include a similarity score, may be used in some examples to determine a level access permissions or authorization for access to one or more portions of the input data by the application. For example, one or more portions of the input data may be determined to comprise sensitive information, for example identification information of one or more users, and such portions of the input data may be allocated a higher permissions or authorization threshold than other less sensitive portions of the input data.

At 1610, the process 1600 further comprises determining, based on the comparison, at least one application of the plurality of applications associated with the first intent.

At 1612, the process 1600 further comprises receiving second input data comprising sensor data characterizing a detection field of at least one sensor. The second input data may, for example be captured following the determination of at least one application and in response thereto. For example, the determined at least one application may be configured to accept input data of a particular input data type or in accordance with a particular input data format or structure. The receiving of the second input data may in such examples be based on the input data type or input data format or structure, which may in some examples be used to modify a capture mode or one or more capture settings or parameters associated with capturing the second input data to be received.

At 1614 of the process 1600, the determined application may be used to perform an operation, the operation based on the second input data and the determined first intent. Thereby, the operation is driven by the determined first intent such that the context associated with the second input data is maintained in the performance of the operation. This feature therefore may provide an end-to-end processing of input data while requiring minimal input commands from a user. It will be appreciated that the first intent may be updated based on the received second input data, for example as described in relation to FIG. 1. In such examples, the performing of the operation may be based on the second input data and the updated first intent.

It will be understood that various modifications may be made to process 300 in accordance with the present disclosure. For example, the steps of the process 300 may be performed in any suitable order.

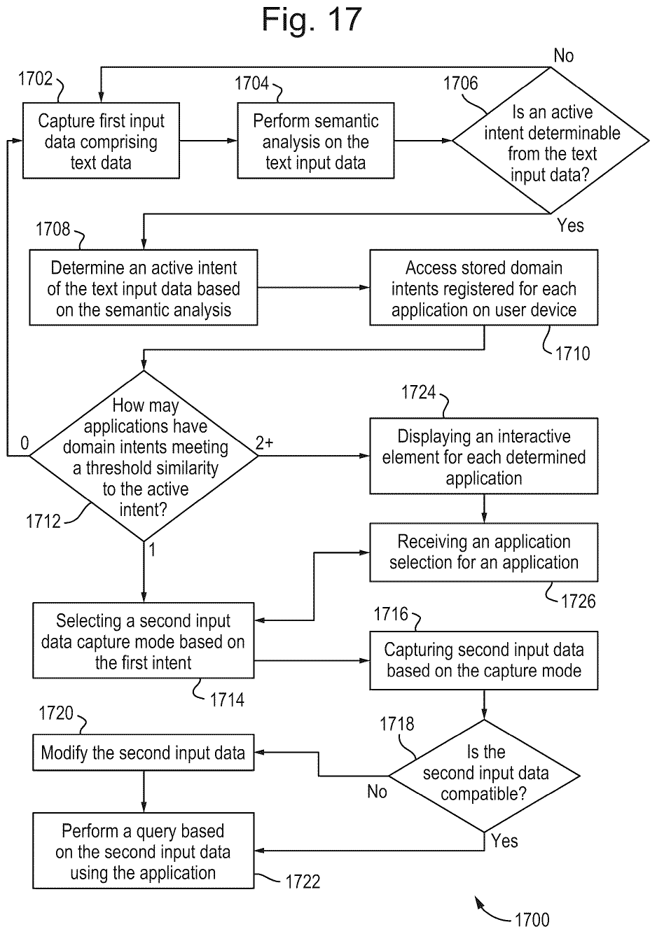

FIG. 17 shows steps of a further example process 1700 of implementing a context-aware clipboard in accordance with some examples of the present disclosure. In the particular example 1700 shown, the process 1700 comprises capturing first input data comprising text data only 1702. The text input data may be received, for example by way of a text input interface receiving text input commands from a user, the text data extracted via the text input interface by any suitable digital data extraction tool or process. At 1704 the process 1700 comprises performing a semantic analysis on the text-only input data, which as described herein can include any suitable semantic processing of the text data. The semantic analysis may be used, for example, extract an active intent or context from the text data. At 1706 of the process 1700, a decision step establishes whether an active intent is determinable from the text input data, based on the semantic analysis. In the event that no active intent is determinable from the text input data, the process may continue to capture first input data comprising text data, at 1702.

In the event that an active intent is determinable from the text input data, at 1708 the process 1700 comprises determining an active intent of the text input data based on the semantic analysis. At 1710, the process 1700 comprises accessing stored domain intents registered for each application stored for execution on a user device, for example the user device via with the text input data was received.

At 1712, a decision step includes performing a comparison assessment between the domain intents and the active intent, the comparison assessment comprising any suitable comparison as described herein, and in particular comprising a determination of how many applications on the user device are identified to have corresponding registered domain intents meeting a threshold similarity to the active intent. In the event that no applications are identified to meet the threshold similarity, the process 1700 may comprise continuing to capture text input data, at 1702.

In the event that a single application is identified to meet the similarity threshold, at 1714 the process 1700 comprises selecting a capture mode for capturing second input data, the selected capture mode based on the first intent. Specific capture parameters may therefore be selected in accordance with a particular determined active intent, for example the capturing of a particular input data type, such as image data or an audio recording.

At 1716, the process 1700 comprises capturing the second input data based on the capture mode. A determination step is performed at 1718 of the process 1700, in which it is determined whether the captured second input data is compatible for use with the determined application. For example, the determined application may comprise specific input data compatibility parameters or formatting. In the event that the captured second input data is determined not to be compatible, for example following a comparison of one or more parameters or file types of the second input data with compatibility data (for example associated metadata) associated with the determined application, at 1720 the second input data is modified for compatibility. For example a data conversion, transformation, data template, reformatting or restructuring may be applied to the second input data such that the second input data is rendered compatible with the determined application. At 1722, the determined application is used to perform an operation thereof, such as a query, based on the second input data, and the active or domain intent.

At the decision step of 1712, if it is determined that more than one application comprises domain intents associated therewith which meet the threshold similarity to the active intent, interactive elements are displayed at 1724 for each determined application, for example as described in relation to FIG. 5. The interactive elements are configured to receive interaction from a user in order to trigger a selection of the application from the more than applications. In some examples, an initial query may be performed by each application using the first input data and a preview of the query results may be displayed as part of the interactive element. At 1726 of the process, a selection of an application from the more than one applications is made, for example by way of a detection of an interaction with one of the interactive elements. As such, interaction and instructions may be received which may control or limit which application or applications are used to perform the operation, optionally based on second input data. In the example 1700 shown, following the selection, the process 1700 continues as described from the step 1714 of selecting a second input data capture mode based on the first intent.

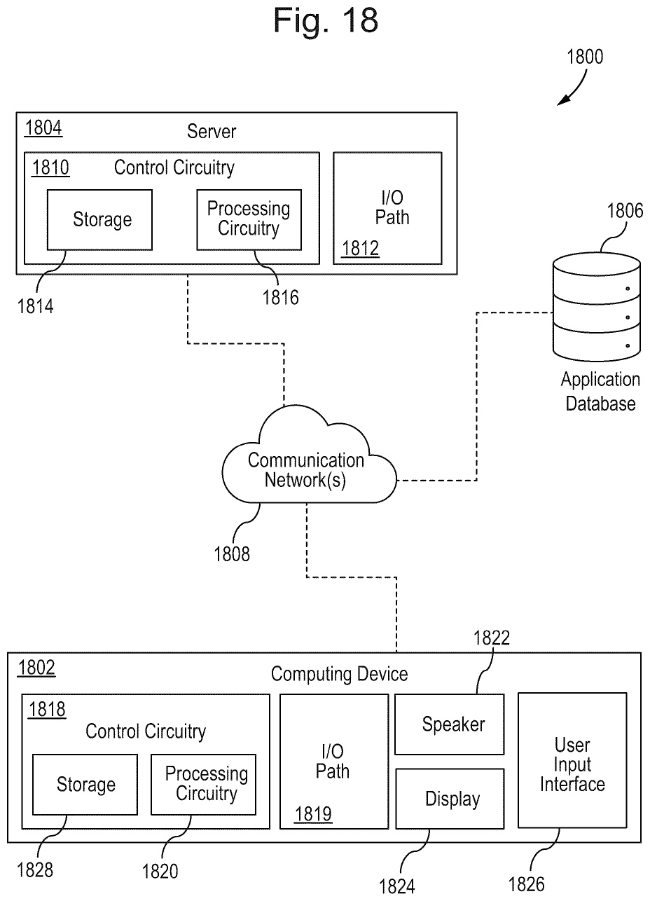

FIG. 18 is an illustrative block diagram showing example system 1800 configured to provide a context-aware clipboard. Although FIG. 18 shows system 1800 as including a number and configuration of individual components, in some examples, any number of the components of system 1800 may be combined and/or integrated as one device, e.g., as user device 110. System 1800 includes computing device 1802, server 1804 (e.g., server 114), and application database or server 1806 (e.g., application database or server 116), each of which is communicatively coupled to communication network 1808 (e.g., network 112), which may be the Internet or any other suitable network or group of networks. In some examples, system 1800 excludes server 1804, and functionality that would otherwise be implemented by server 1804 is instead implemented by other components of system 1800, such as computing device 1802. In still other examples, server 1804 works in conjunction with computing device 1802 to implement certain functionality described herein in a distributed or cooperative manner.

Server 1804 includes control circuitry 1810 and input/output (hereinafter “I/O”) path 1812, and control circuitry 1810 includes storage 1814 and processing circuitry 1816, which may comprise imaging processing circuitry. Computing device 1802, which may be a user device such as an extended reality device for example comprising a HMD, a personal computer, a laptop computer, a tablet computer, a smartphone, a smart television, a smart speaker, or any other type of computing device, includes control circuitry 1818, I/O path 1819, speaker 1822, display 1824, and user input interface 1826. Control circuitry 1818 includes storage 1828 and processing circuitry 1820. Control circuitry 1810 and/or 1818 may be based on any suitable processing circuitry such as processing circuitry 1816 and/or 1820. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 1814, storage 1828, and/or storages of other components of system 1800 (e.g., storages of application database or server 1806, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid-state devices, quantum storage devices, gaming consoles, gaming media, or any other suitable fixed or removable storage devices, and/or any combination of the same. Each of storage 1814, storage 1828, and/or storages of other components of system 1800 may be used to store various types of content, metadata, and or other types of data. Non-volatile memory may also be used (e.g., to launch a boot-up routine and other instructions). Cloud-based storage may be used to supplement storages 1814, 1828 or instead of storages 1814, 1828. In some examples, control circuitry 1810 and/or 1818 executes instructions for an application stored in memory (e.g., storage 1814 and/or 1828). Specifically, control circuitry 1814 and/or 1828 may be instructed by the application to perform the functions discussed herein. In some implementations, any action performed by control circuitry 1814 and/or 1828 may be based on instructions received from the application. For example, the application may be implemented as software or a set of executable instructions that may be stored in storage 1814 and/or 1828 and executed by control circuitry 1814 and/or 1828. In some examples, the application may be a client/server application where only a client application resides on computing device 1802, and a server application resides on server 1804.

The application may be implemented using any suitable architecture. For example, it may be a stand-alone application wholly implemented on computing device 1802. In such an approach, instructions for the application are stored locally (e.g., in storage 1828), and data for use by the application is downloaded on a periodic basis (e.g., from an out-of-band feed, from an Internet resource, or using another suitable approach). Control circuitry 1818 may retrieve instructions for the application from storage 1828 and process the instructions to perform the functionality described herein. Based on the processed instructions, control circuitry 1818 may determine what action to perform when input is received from user input interface 1826.

In client/server-based examples, control circuitry 1818 may include communication circuitry suitable for communicating with an application server (e.g., server 1804) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1808). In another example of a client/server-based application, control circuitry 1818 runs a web browser that interprets web pages provided by a remote server (e.g., server 1804). For example, the remote server may store the instructions for the application in a storage device. The remote server may process the stored instructions using circuitry (e.g., control circuitry 1810) and/or generate displays. Computing device 1802 may receive the displays generated by the remote server and may display the content of the displays locally via display 1824. This way, the processing of the instructions is performed remotely (e.g., by server 1804) while the resulting displays, such as the display windows described elsewhere herein, are provided locally on computing device 1802. Computing device 1802 may receive inputs from the user via input interface 1826 and transmit those inputs to the remote server for processing and generating the corresponding displays.

A user may send instructions, e.g., to capture input data or provide input commands, to control circuitry 1810 and/or 1818 using user input interface 1826. User input interface 1826 may be any suitable user interface, such as a remote control, trackball, keypad, keyboard, touchscreen, touchpad, stylus input, joystick, voice recognition interface, gaming controller, or other user input interfaces. User input interface 1826 may be integrated with or combined with display 1824, which may be a monitor, a television, a liquid crystal display (LCD), an electronic ink display, or any other equipment suitable for displaying visual images.

Server 1804 and computing device 1802 may transmit and receive content and data via I/O path 1812 and 1819, respectively. For instance, I/O path 1812 and/or I/O path 1819 may include a communication port(s) configured to transmit and/or receive (for instance to and/or from application database or server 1806), via communication network 1808, content item identifiers, content metadata, natural language queries, and/or other data. Control circuitry 1810, 1818 may be used to send and receive commands, requests, and other suitable data using I/O paths 1812, 1819.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

The present disclosure may be further understood with reference to the following paragraphs.

In some examples, systems and methods are provided for enhancing the capture, processing, and integration of data using a device sensor, such as a device camera. By introducing concepts such as domain intent and active intent, systems and methods are provided taking a context-aware approach configured to tailor data handling process to the specific needs of an application in use. Presently disclosed systems and methods may introduce features such as persistent and context-aware clipboard management, and cross-device data integration. The systems and methods may, in some examples, support the use of one or more data templates, which may be customizable data templates, and may employ contextual awareness to automatically adjust one or more input data capture settings, for example based on environmental conditions and the type or properties of input data being captured, while considering the active intent or domain intent.

In some examples, systems and methods may be provided for capturing, processing, and integrating content from a device sensor, such as a mobile device camera, into a target application, enhancing functionality for search, recommendation, visual data tagging, and augmented reality (AR) visualization. Such systems and methods may leverage any suitable semantic analysis, and may introduce the concepts of domain intent and active intent, as discussed herein, to guide the system or process.

The system or method may, for example, begin when an input data capture process is initiated on the device, for example in response to receiving an indication of a selection of a target application. The process may be initiated in any suitable manner, for example in response to receiving an indication of a input gesture, such as a touch or option selection, on a touchscreen interface. In some examples, the process may be initiated in response to one or more input instructions to launch an application, for example a camera application, or using a digital assistant like Siri or Google Assistant to specify an active intent. For example, input data may be detected or determined in the form of speech from a user, which may be determined to say, “I am looking for a sofa to fit in this space”, while pointing a sensor, such as camera, at an area of interest. Methods or systems in some examples may perform any appropriate semantic analysis on the input data, such as the speech data, and may simultaneously, or as a result, capture input data comprising sensor data, such as camera data characterizing a field of view of the camera. The process may comprise determining an active intent associated with the input data, for example the speech data, the sensor data, or any suitable combination thereof. Following the determination of an active intent, example systems and methods may display or suggest one or more applications having registered domain intents associated with the determined active intent. In some examples, systems and methods may pre-fill or generate one or more queries, for example based on the input data or the active intent, so that when an application is launched, such as when the user selects the application to be launched, query results are associated with the input data or the determined active intent. In one example a user may select an application for a furniture manufacturer, the search results being pre-tailored to display sofas fitting a space or matching a color scheme determined from input image data. Further input data, such as input commands or instructions, may be received at a user device, such as to refine any query results, and in accordance with some examples of the present systems and methods, such further input data or refinement may be used to modify or adjust the determined active intent. In some examples the modified active intent may trigger the determination of one or more different applications, the different applications having registered domain intents more closely associated with the adjusted or modified active intent. In some examples, instructions may be received to launch a different one of the one or more applications on the device, and in such examples, the input data or the further input data, or any combination thereof may also be accessible the different application.

In some examples, once the process is initiated, the process or system may comprise identifying one or more types of input data, one or input data structures, or one or more input data formats, that the selected application is configured to accept, such as images, text, PDFs, or spatial data. This compatibility information may be predefined, for example in a setting or file associated with the application, such as a configuration file of the application (e.g., the Info.plist in iOS or the AndroidManifest.xml in Android). The identified input data types, structures or formats may be used in any semantic analysis associated with the present systems or methods, and for example may be used by an operating system of a device to communicate with a semantic system, such as part of a separate clipboard management system or as part of the user device. Example systems and methods may be configured to offload any data processing, analysis or storage steps to a remote processing or storage device, such as a cloud processing or storage device, for example to reduce the processing or storage load on a local device. Example systems and methods may be configured to generate one or more data inputs having specific data characteristics, such as image size, aspect ratio, format, or 3D spatial data, which may for example be tailored to one or more input requirements of an application. In some examples, systems and methods may be configured to make any modifications or adjustments to received input data, based on the one or more input requirements of an application.

The present disclosure describes the concept of a “domain intent” associated with an application, which is intended to represent, and will be understood as representing, the broad operational purpose of the associated application, such as furniture shopping, home design, or document editing. The domain intent may for example be used to inform a context-aware processing, data integration, and AR interaction of systems and devices of the present disclosure, and may ensure that the captured input data or content aligns with the available operation and functioning of an application. Applications may be configured to register one or more associated domain intents at any suitable registry on a memory or storage location, and the registration may for example be performed statically, such as through one or more configuration files associated with the application, or dynamically at runtime. By way of example, on iOS, a domain intent of an application may be specified in the Info.plist file of an application or updated dynamically by way of an operating system-level application programming interface (API). On Android, a domain intent may for example be declared in the AndroidManifest.xml file using a <meta-data> tag or registered dynamically via an API call.

The present disclosure describes the concept of an “active intent”, which may be determined based on one or more input data, and is intended to represent a more specific or temporary focus, and may in some examples represent a more specific or temporary focus within an associated domain intent. In some examples, the active intent may also be defined by an application. By way of example, a furniture shopping application may have an associated domain intent for “furniture shopping,” and may switch between active intents associated with this domain intent, for example “room layout” and “product selection”.

Following the launch of an application or defining the active or domain intent, examples of the present system or method may be configured to adapt a user interface to minimize distractions, providing an unobstructed view for capturing input data or content. Input data may captured using one or more sensors of any suitable device, such as a mobile device of a user, the input data being any suitable type, and may for example be of an input data type associated with an application, such as an operation or function thereof. Example systems and methods may be configured to perform a semantic analysis on the input data, for example a real-time semantic analysis, which may be performed by a dedicated semantic system. As part of the processing of the input data, such as by way of semantic analysis, one or more input data extraction options may be output, for example by way of a display screen or speakers of a user device, each option associated with a corresponding input data extraction process, such as image processing, optical character recognition (OCR) for text conversion, spatial data extraction, or PDF generation. Following an indication of a selection of one of the options, for example representing a selection of a desired data type, example systems and methods may process and/or convert the captured input data or content, which may for example be directly integrated into a target application. Such a process may act in streamlining a workflow. Example systems and methods may be configured to store the original input data or content, allowing for further data extraction without needing to recapture the information.

In some examples, the active intent or domain intent may act to enhance extended reality experiences, such as augmented reality (AR) experiences, along with other advanced features. In some example systems and methods, an application may be configured to support extended reality functionality, such as AR functionality. In some such examples, the systems and methods may be configured to select, using the determined active intent, or a domain intent of an application, to select one or more extended reality features, content, settings or interactions, for example the most relevant extended reality features, content, settings or interactions. For example, in a furniture shopping app, a system may prioritize AR overlays that help with spatial fit, style matching, and color coordination based on the semantic analysis of the captured environment. In some examples, the extended reality features, content, settings or interactions may be screened, pre-filtered and/or customized based on the determined active intent or a domain intent of an application, and may ensure that a user receives options directly relevant to a current task.

In some examples, systems and methods may be configured to perform visual tagging based on the determined active intent or the domain intent of an application. For example, systems and methods may be configured to recognize, identify and tag key visual elements within captured input data images, for example based on a level of association or relevance to the determined active intent or the domain intent of an application. Such tags may be stored in any suitable memory as described herein. For example, in a home design application, a system or method may be configured to tag furniture types, colors, and patterns, generating metadata that enhances a search function, a recommendation, or visualization capabilities of the application. Such tags may act to improve future interactions by making the captured data more easily searchable and usable within the application.

In some examples of systems and methods configured to support extended reality functionality, such systems and methods may be configured to output or display captured input data in an extended reality view, for example directly on a display screen of an extended reality-enabled device. This extended reality view may be contextualized based on the determined active intent or the domain intent of an application, and may allow a user to visualize relevant content, such as furniture placements, design layouts, or document enhancements, for example based on a function or operation associated with the application. Example systems and methods may be configured to dynamically adapt an extended reality experience based on ongoing or current activity within an application, for example based on received input data associated with interactions or input commands, which may ensure that any output or displayed content remains relevant and useful. Any suitable extended reality-enabled device will be envisaged, and may for example comprise a head-mounted display, and the presently disclosed functionality may thereby provide broad applicability across different hardware platforms. Received input data may be transferred to the appropriate clipboard memory, which may be for example based on the determined active intent or the domain intent of an application, which may involve any suitable storage of the received input data, for example local device storage or a remote storage solution, such as a cloud-based datastore.

In some examples, systems and methods may be configured to enable cross-device input data capture, integration and storage. In such examples, a first device may be configured for capturing, and optionally processing, input data or content, and captured, and optionally processed, input data may be transmitted to a second device for further use in accordance with the present systems and methods. Examples will be appreciated within the scope of the present disclosure which comprise any suitable combination of two or more devices for implementing systems and methods of the present disclosure. Such cross-device enabled embodiments may act to enhance user productivity by allowing users to leverage the strengths of different devices for corresponding parts of the presently disclosed implementation, such as using a mobile phone camera to capture input image or spatial data, before transmitting the input data, or a processed version thereof, to a laptop for editing or presentation.

Systems or methods may, for example, allow a user to initiate input data capture on a first device, such as a smartphone or tablet, which is equipped with a camera and other input sensors. The captured input data or content may for example include images, text, spatial data, or any other relevant information. The example system or method may then comprise performing real-time processing of the captured input data, applying one or more operations such as image extraction, optical character recognition (OCR), or spatial analysis. Following the data processing, the example systems or methods may be configured to automatically transmit the processed input data to a second device, such as a laptop or desktop computer, where the processed input data may be further utilized. The transmission of data between devices may be facilitated using any suitable technology and may in some examples be performed using a secure communication protocol, such as Wi-Fi, Bluetooth, or a cloud-based service. In some examples, instructions may be received, for example from a user, specifying a target device for performing one or more steps of the method, or for receiving data at one or more points during the method. For example, the instructions may be received during initial setup or at any point during the present implementations, for example by way of an application interface. For example, after capturing a document on a smartphone, a user may choose to send the extracted text directly to a document editor on their laptop, where it may be automatically opened for further editing. Some examples may comprise real-time synchronization between devices, for example allowing for continuous data transfer as content is captured and processed. For example, in a meeting setting, a user could capture whiteboard notes with their phone, and the processed text could be immediately available on a laptop for collaborative editing or sharing with others.

Example systems and methods may be configured to providing data privacy and security, for example by performing any suitable encryption of the captured, received or processed input data at any point of the present systems or methods, for example prior to or during transmission of the data. Some examples may be configured to receive data access control, authorization or permission instructions, and may be further configured to control access to, or transmission of, the input data from one or more applications or devices. The instructions may, for example be configured to provide options for a user to control input data access permissions. Examples systems and methods may also be configured to receive instructions for storing captured or received input data, for example one or more storage locations. The one or more storage locations maybe any suitable storage location, for example local storage of an input data capturing device or an input data receiving device, or remotely thereto.

The following provides an example clipboard structure, with example data showing the domain intent and potential active intents for various captured parameters:

```
{
  “clipboard_id”: “shared_clipboard_123”,
  “data”: [
    {
      “type”: “spatial”,
      “content”: {
        “spatial_coordinates”: [
          {“x”: 0, “y”: 0, “z”: 0},
          {“x”: 5.5, “y”: 0, “z”: 4.0}
        ],
        “bounding_boxes”: [
          {“label”: “sofa”, “min_corner”: {“x”: 1.0, “y”: 0.0, “z”: 0.0},
“max_corner”: {“x”: 3.0, “y”: 0.0, “z”: 1.0}}
        ]
      },
      “domain_intent”: “room_planning”,
      “active_intents”: [“capture_dimensions”, “analyze_space”]
      “type”: “text”,
      “content”: “This is a sample text that describes the room layout.”,
      “domain_intent”: “documentation”,
      “active_intents”: [“write_summary”, “describe_layout”]
      “type”: “audio”,
      “content”: “base64_encoded_audio_data”,
      “domain_intent”: “voice_notes”,
      “active_intents”: [“record_notes”, “playback”]
    },
    {
      “type”: “color”,
      “content”: {
        “palette”: [“#ff5733”, “#33ff57”, “#3357ff”]
      },
      “domain_intent”: “interior_design”,
      “active_intents”: [“extract_palette”, “match_colors”]
    },
    {
      “type”: “image”,
      “content”: “base64_encoded_image_data”,
      “domain_intent”: “visual_reference”,
      “active_intents”: [“capture_image”, “analyze_image”]
    }
  ],
  “metadata”: {
    “timestamp”: “2024-08-17T12:34:56Z”,
    “source_application”: “RoomCaptureApp”
  }
}
```

The following is an example of an input data template of an application configured for capturing spatial data (e.g., for searching for a sofa in a room using the spatial capture system of a mobile device):

```
{
  “template_name”: “Standard_SpatialDataCapture”,
  “data_types”: {
    “spatial_coordinates”: [“x”, “y”, “z”],
    “slam_data”: {
      “point_cloud_format”: “PLY”,
      “pose_estimation”: [“quaternion”, “euler_angles”],
      “trajectory”: “6DoF_path”
    },
    “surface_mapping”: “3D_mesh”,
    “object_data”: [“bounding_boxes”, “segmentation”]
  },
  “input_parameters”: {
    “spatial_coordinates”: {
      “format”: “JSON”,
      “required_data”: [
```

{“x”: 0, “y”: 0, “z”: 0},
{“x”: 5.5, “y”: 0, “z”: 0},
{“x”: 5.5, “y”: 0, “z”: 4.0},
{“x”: 0, “y”: 0, “z”: 4.0}

```
      ]
    },
    “slam_data”: {
      “format”: “dense_point_cloud”,
      “localization”: {
      “quaternion”: [0.707, 0, 0.707, 0],
      “euler_angles”: {“roll”: 0, “pitch”: 0, “yaw”: 90}
    },
    “trajectory”: [
      {“x”: 0, “y”: 0, “z”: 0},
      {“x”: 1, “y”: 0, “z”: 0},
      {“x”: 2, “y”: 0, “z”: 0}
    ]
  },
  “object_data”: {
    “bounding_boxes”: [
```

| | |
|---|---|
| | {“label”: “sofa”, “min_corner”: {“x”: 1.0, “y”: 0.0, “z”: 0.0}, |
| “max_corner”: | {“x”: 3.0, “y”: 0.0, “z”: 1.0}}, |
| | {“label”: “table”, “min_corner”: {“x”: 3.5, “y”: 0.0, “z”: 1.0}, |

```
“max_corner”: {“x”: 4.5,“y”: 0.0, “z”:2.0}}
      ],
      “segmentation”: “semantic_mask_data_here”
    }
  },
  “processing”: {
    “point_cloud_processing”: “noise_reduction”,
    “surface_reconstruction”: “mesh_generation”,
    “spatial_analysis”: “available_space”
  },
  “output_parameters”: {
    “3D_model_export”: {
      “format”: “GLTF”,
      “data”: “encoded_3d_model_data_here”
    },
    “spatial_data_export”: {
      “format”: “JSON”,
      “data”: [
```

{“coordinate”: {“x”: 0, “y”: 0, “z”: 0}},
{“object_position”: {“sofa”: {“x”: 1.0, “y”: 0.0, “z”: 0.0}}}

```
      ]
    }
  }
}
```

1. A method for providing a context-aware clipboard, the method comprising:
receiving, using control circuitry, input data comprising sensor data characterizing a detection field of at least one sensor;
determining, using control circuitry, a first intent associated with the input data;
accessing, using control circuitry, one or more second intents, each second intent associated with an application of a plurality of applications;
comparing, using control circuitry, the first intent with the accessed one or more second intents;
determining, using control circuitry, based on the comparison, at least one application of the plurality of applications associated with the first intent; and
performing, using control circuitry, an operation using the determined application, the operation based on the input data and the determined first intent.

2. The method of claim 1, wherein the determining of the first intent comprises performing a semantic analysis on at least a portion of the input data.

3. The method of claim 2, wherein the input data comprises text or language data.

4. The method of claim 2, wherein the sensor data comprises image data characterizing a field of view of an imaging device, and wherein the semantic analysis comprises semantic segmentation of the image data.

5. The method of claim 1, further comprising, following the determining of the application:
outputting, using control circuitry, an interactive element associated with the at least one determined application; and
receiving, using control circuitry, an indication of an interaction with the interactive element.

6. The method of claim 1, wherein the operation comprises:
generating, using the input data, a query based on the first intent; and
performing the query using the at least one determined application.

7. The method of claim 1, further comprising:
formatting or structuring the input data based on the at least one determined application.

8. The method of claim 7, wherein the formatting or structuring is based on a predetermined data template associated with the at least one determined application.

9. The method of claim 1, further comprising:
storing the determined first intent;
receiving instructions to execute a second application of the plurality of applications; accessing the stored first intent; and
performing a second operation using the second application, the operation based on the input data and the stored first intent.

10. The method of claim 1, further comprising:
receiving second input data; and
modifying the first intent based on the second input data.

11. A system for providing a context-aware clipboard, the system comprising:
control circuitry configured to:
receive input data comprising sensor data characterizing a detection field of at least one sensor;
determine a first intent associated with the input data;
access one or more second intents, each second intent associated with an application of a plurality of applications;
compare the first intent with the accessed one or more second intents;
determine, based on the comparison, at least one application of the plurality of applications associated with the first intent; and
perform an operation using the determined application, the operation based on the input data and the determined first intent.

12. The system of claim 11, wherein the determining of the first intent comprises performing a semantic analysis on at least a portion of the input data.

13. The system of claim 12, wherein the input data comprises text or language data.

14. The method of claim 12, wherein the sensor data comprises image data characterizing a field of view of an imaging device, and wherein the semantic analysis comprises semantic segmentation of the image data.

15. The system of claim 11, wherein the control circuitry is further configured to, following the determining of the application:
output an interactive element associated with the at least one determined application; and receive an indication of an interaction with the interactive element.

16. The system of claim 11, wherein the operation comprises:
generating, using the input data, a query based on the first intent; and
performing the query using the at least one determined application.

17. The system of claim 11, wherein the control circuitry is further configured to:
format or structure the input data based on the at least one determined application.

18. The system of claim 17, wherein the formatting or structuring is based on a predetermined data template associated with the at least one determined application.

19. The system of claim 11, wherein the control circuitry is further configured to:
store the determined first intent;
receive instructions to execute a second application of the plurality of applications; access the stored first intent; and
perform a second operation using the second application, the operation based on the input data and the stored first intent.

20. The system of claim 11, wherein the control circuitry is further configured to:
receive second input data; and
modify the first intent based on the second input data.

21.-50. (canceled)
